(19) United States
(12) Patent Application Publication
(10) Pub. No.: US 2025/0136206 A1
(43) Pub. Date: May 1, 2025

(54) DEVICES AND SYSTEMS FOR LOCOMOTING DIVERSE TERRAIN AND METHODS OF USE

(71) Applicant: GEORGIA TECH RESEARCH CORPORATION, Atlanta, GA (US)

(72) Inventors: Velin KOJOUHAROV, Atlanta, GA (US); Tianyu WANG, Atlanta, GA (US); Daniel GOLDMAN, Atlanta, GA (US); Daniel SOTO, Atlanta, GA (US); Baxi ZHONG, Atlanta, GA (US); Juntao HE, Atlanta, GA (US); Yasemin OZKAN-AYDIN, Atlanta, GA (US)

(21) Appl. No.: 18/691,750

(22) PCT Filed: Sep. 13, 2022
(86) PCT No.: PCT/US2022/043362

§ 371 Date: Mar. 13, 2024

Related U.S. Application Data
(60) Provisional application No. 63/243,435, filed on Sep. 13, 2021.
(60) Provisional application No. 63/318,868, filed on Mar. 11, 2022.

(51) Int. Cl. B62D 57/032; B25J 9/08; B25J 9/10

(52) U.S. Cl. CPC B62D 57/032; B25J 9/08; B25J 9/1075

(57) ABSTRACT

Various implementations include a limbed robotic module. The module includes a frame, a first and second motor, a yoke, and a leg. The first motor is rigidly coupled to the frame and has a rotatable first shaft. The second motor is rigidly coupled to the frame and has a rotatable second shaft. The yoke is rigidly coupled to the first shaft such that rotation of the first shaft rotates the yoke relative to the frame. The yoke has a shoulder extending radially outwardly from the first shaft. The leg has a first end, a second end, and a hinge portion disposed between the first and second ends. The hinge portion is hingedly coupled to the shoulder of the yoke. The first end is coupled to the second shaft such that rotation of the second shaft rotates the second end relative to the yoke.

### RELATED APPLICATION

This international PCT application claims priority to, and the benefit of, U.S. Provisional Patent Application No. 63/243,435, filed Sep. 13, 2021, entitled “Device to Locomate in Diverse Terrain,” and U.S. Provisional Patent Application No. 63/318,868, filed Mar. 11, 2022, entitled “Limbless Robots,” each of which is incorporated by reference herein in its entirety.

### STATEMENT OF GOVERNMENT SUPPORT

This invention was made with government support under grant no. 1933283 awarded by National Science Foundation and grant no. W911NF1910233 awarded by the Army Research Office Multidisciplinary University Research Initiative. The government has certain rights in the invention.

### BACKGROUND

Bilaterally activated robots with soft limbless locomotors are being explored in new areas of research. These multi-segmented robots are configured to mimic the movements of that of snakes. Early generation designs of such snake-like robots are configured with (i) muscle morphology to mimic the bilateral motion of serpents using pairs of actuators, one on each side of the spine to create body bending movement by a unilateral contraction of those actuator pairs and (ii) the corresponding activation patterns for controls.

Multi-legged systems are also being explored in areas of research. These multi-segmented robots are configured to mimic the movements of that of centipedes. Early generation designs of centipede-like robots are configured with a segment frame supported by a pair of limbs in which the segments are motorized to move with respect to another segment frame.

Such limbed and limbless robots still have had limited success in navigating obstacle-ridden terrain and are still outperformed in mobility by their natural biological counterparts.

Thus, a need exists for a robot design that addresses these current limitations with the state of the art design.

### SUMMARY

Various implementations include a limbed robotic module. The module includes a frame, a first leg motor, a second leg motor, a yoke, and a leg. The first leg motor is rigidly coupled to the frame and has a first leg shaft that is rotatable about a first leg rotational axis. The second leg motor is rigidly coupled to the frame and has a second leg shaft that is rotatable about a second leg rotational axis. The first leg rotational axis is transverse to the second leg rotational axis. The yoke is rigidly coupled to the first leg shaft such that rotation of the first leg shaft about the first leg rotational axis rotates the yoke relative to the frame. The yoke has a shoulder extending radially outwardly from the first leg rotational axis. The leg has a first leg end, a second leg end opposite and spaced apart from the first leg end, and a leg hinge portion disposed between the first leg end and the second leg end. The leg hinge portion is hingedly coupled to the shoulder of the yoke. The first leg end is coupled to the second leg shaft such that rotation of the second leg shaft about the second leg rotational axis rotates the second leg end relative to the yoke.

In some implementations, the shoulder of the yoke is a first shoulder. The yoke further includes a second shoulder extending radially outwardly from the first leg rotational axis. The leg is a first leg. The module further includes a second leg having a first leg end, a second leg end opposite and spaced apart from the first leg end, and a leg hinge portion disposed between the first leg end of the second leg and the second leg end of the second leg. The leg hinge portion of the second leg is hingedly coupled to the second shoulder of the yoke. The first leg end of the second leg is coupled to the second leg shaft such that rotation of the second leg shaft about the second leg rotational axis rotates the second leg end of the second leg relative to the yoke.

In some implementations, the first leg end is coupled to the second leg shaft by a flexible leg tendon. In some implementations, the module further includes an extended linkage rigidly coupled to the second leg shaft. The extended linkage has a protrusion extending radially outwardly from the second leg rotational axis. The leg tendon is coupled to the protrusion.

In some implementations, the leg includes a first leg segment including the first leg end and a second leg segment including the second leg end. The first leg segment is hingedly coupled to the second leg segment. In some implementations, the second leg segment is resiliently rotatable relative to the first leg segment such that the second leg segment is biased by a spring force toward a first leg position and urgable toward a second leg position. An angle between a longitudinal axis of the first leg segment and a longitudinal axis of the second leg segment is larger in the first leg position than in the second leg position. In some implementations, the spring force is caused by a resilient member.

In some implementations, the leg hinge portion is resiliently rotatable relative to the shoulder of the yoke such that the leg is biased by a spring force toward a first shoulder position and urgable toward a second shoulder position. An angle between a longitudinal axis of the shoulder and a longitudinal axis of the leg is larger in the first shoulder position than in the second shoulder position. In some implementations, the spring force is caused by a resilient member.

In some implementations, the first leg motor and the second leg motor are each servo motors.

Various other implementations include a limbed robotic system. The system includes a first module as described above and a second module. The first module is hingedly coupled to the second module.

In some implementations, the second module is a module as described above.

In some implementations, the system further includes a third module as described above. The second module is hingedly coupled to the third module.

In some implementations, the first module further includes a first body motor coupled to the frame of the first module and having a first body shaft that is rotatable about a first body rotational axis. The second module is rigidly coupled to the first body shaft such that rotation of the first body shaft about the first body rotational axis rotates the second module relative to the first module.

In some implementations, the first module further includes a second body motor coupled to the frame of the first module and having a second body shaft that is rotatable about a second body rotational axis. The second body rotational axis is transverse to the first body rotational axis. The frame of the first module is rigidly coupled to the second body shaft and the second body motor is rigidly coupled to the first body motor such that rotation of the second body shaft about the second body rotational axis rotates the second body motor relative to the frame of the first module.

In some implementations, the first body motor and the second body motor are disposed within a same motor housing. In some implementations, the first body motor and the second body motor are each servo motors.

In some implementations, the leg tendon is a first leg tendon. The first module further includes a first body motor, a second body motor, a first spool, a second spool, a flexible first body tendon, and a flexible second body tendon. The first body motor is rigidly coupled to the frame and has a first body shaft that is rotatable about a first body rotational axis. The second body motor is rigidly coupled to the frame and has a second body shaft that is rotatable about a second body rotational axis. The first spool is rigidly coupled to the first body shaft such that rotation of the first body shaft about the first body rotational axis rotates the first spool relative to the frame. The second spool is rigidly coupled to the second body shaft such that rotation of the second body shaft about the second body rotational axis rotates the second spool relative to the frame. The first body tendon has a first portion and a second portion spaced apart from the first portion. The first portion of the first body tendon is coupled to the first spool such that rotation of the first spool about the first body rotational axis winds the first body tendon about the first spool. The second body tendon has a first portion and a second portion spaced apart from the first portion. The first portion of the second body tendon is coupled to the second spool such that rotation of the second spool about the second body rotational axis winds the second body tendon about the second spool. The second portion of the first body tendon and the second portion of the second body tendon are coupled to a frame of the second module such that winding of the first body tendon about the first spool causes the second module to rotate relative to the first module in a first direction and winding of the second body tendon about the second spool causes the second module to rotate relative to the first module in a second direction. The first direction is an opposite rotational direction than the second direction.

In some implementations, the first body motor and the second body motor are disposed within a same motor housing. In some implementations, the first body motor and the second body motor are each servo motors.

In some implementations, the second module is a module as described above.

In some implementations, the second module is resiliently rotatable relative to the first module such that the second module is biased by a spring force toward a neutral position and urgable in the first direction. A longitudinal axis of the first module is parallel to a longitudinal axis of the second module in the neutral position. In some implementations, the spring force is caused by a resilient member.

In some implementations, the spring force is a first spring force. The second module is resiliently rotatable relative to the first module such that the second module is biased by a second spring force toward the neutral position and urgable in the second direction. In some implementations, the second spring force is caused by a resilient member.

In some implementations, the frame of the second module is hingedly coupled to the frame of the first module by a hinge joint. In some implementations, the hinge joint defines an opening extending from the first module to the second module.

In some implementations, the system further includes a first tendon guide and a second tendon guide. The first body tendon extends through the first tendon guide and the second body tendon extends through the second tendon guide. In some implementations, a portion of the first body tendon extending from the first tendon guide to a frame of the second module is parallel to a longitudinal axis of the first module when the second module is in a neutral position. A portion of the second body tendon extending from the second tendon guide to the frame of the second module is parallel to the longitudinal axis of the first module when the second module is in the neutral position. The longitudinal axis of the first module is parallel to a longitudinal axis of the second module in the neutral position.

In some implementations, the first module further includes a third body motor, a fourth body motor, a third spool, a fourth spool, a flexible third body tendon, and a flexible fourth body tendon. The third body motor is rigidly coupled to the frame and has a third body shaft that is rotatable about a third body rotational axis. The fourth body motor is rigidly coupled to the frame and has a fourth body shaft that is rotatable about a fourth body rotational axis. The third spool is rigidly coupled to the third body shaft such that rotation of the third body shaft about the third body rotational axis rotates the third body spool relative to the frame. The fourth spool is rigidly coupled to the fourth body shaft such that rotation of the fourth body shaft about the fourth body rotational axis rotates the fourth spool relative to the frame. The third body tendon has a first portion and a second portion spaced apart from the first portion. The first portion of the third body tendon is coupled to the third spool such that rotation of the third spool about the third body rotational axis winds the third body tendon about the third spool. The fourth body tendon has a first portion and a second portion spaced apart from the first portion. The first portion of the fourth body tendon is coupled to the fourth spool such that rotation of the fourth spool about the fourth body rotational axis winds the fourth body tendon about the fourth spool. The second portion of the third body tendon and the second portion of the fourth body tendon are coupled to the frame of the second module such that winding of the third body tendon about the third spool causes the second module to rotate relative to the first module in a third direction and winding of the fourth body tendon about the fourth spool causes the second module to rotate relative to the first module in a fourth direction. The third direction is an opposite rotational direction than the fourth direction.

In some implementations, the first body motor, the second body motor, the third body motor, and the fourth body motor are disposed within a same motor housing. In some implementations, the first body motor, the second body motor, the third body motor, and the fourth body motor are each servo motors.

In some implementations, the module further includes a third tendon guide and a fourth tendon guide.

Various other implementations include a limbless robotic module. The module includes a frame, a first body motor, a first spool, and a second spool. The first body motor is rigidly coupled to the frame and has a first body shaft that is rotatable about a first body rotational axis. The second body motor is rigidly coupled to the frame and has a second body shaft that is rotatable about a second body rotational axis. The first spool is rigidly coupled to the first body shaft such that rotation of the first body shaft about the first body rotational axis rotates the first spool relative to the frame. The second spool is rigidly coupled to the second body shaft such that rotation of the second body shaft about the second body rotational axis rotates the second spool relative to the frame.

In some implementations, the first body motor and the second body motor are disposed within a same motor housing. In some implementations, the first body motor and the second body motor are each servo motors.

In some implementations, the module further includes a first tendon guide and a second tendon guide.

In some implementations, the module further includes one or more wheels rotatably coupled to the frame. In some implementations, the one or more wheels rotate about a wheel rotational axis. In some implementations, the wheel rotational axis is perpendicular to a longitudinal axis of the module.

In some implementations, the module further includes a skin covering the frame, the first body motor, the second body motor, the first spool, and the second spool. In some implementations, the skin includes a resilient material.

In some implementations, the module further includes a third body motor, a fourth body motor, a third spool, and a fourth spool. The third body motor is rigidly coupled to the frame and has a third body shaft that is rotatable about a third body rotational axis. The fourth body motor is rigidly coupled to the frame and has a fourth body shaft that is rotatable about a fourth body rotational axis. The third spool is rigidly coupled to the third body shaft such that rotation of the third body shaft about the third body rotational axis rotates the third spool relative to the frame. The fourth spool is rigidly coupled to the fourth body shaft such that rotation of the fourth body shaft about the fourth body rotational axis rotates the fourth spool relative to the frame.

In some implementations, the module further includes a third tendon guide and a fourth tendon guide.

Various other implementations include a limbless robotic system. The system includes a first module as described above and a second module. The first module further includes a flexible first body tendon and a flexible second body tendon. The first body tendon has a first portion and a second portion spaced apart from the first portion. The first portion of the first body tendon is coupled to the first spool such that rotation of the first spool about the first body rotational axis winds the first body tendon about the first spool. The second body tendon has a first portion and a second portion spaced apart from the first portion. The first portion of the second body tendon is coupled to the second spool such that rotation of the second spool about the second body rotational axis winds the second body tendon about the second spool. The second module includes a frame. The frame of the second module is hingedly coupled to the frame of the first module. The second portion of the first body tendon and the second portion of the second body tendon are coupled to the frame of the second module such that winding of the first body tendon about the first spool causes the second module to rotate relative to the first module in a first direction and winding of the second body tendon about the second spool causes the second module to rotate relative to the first module in a second direction. The first direction is an opposite rotational direction than the second direction.

In some implementations, the second module is a module as described above.

In some implementations, he system further includes a third module as described above. The frame of the third module is hingedly coupled to the frame of the second module.

In some implementations, the second module is resiliently rotatable relative to the first module such that the second module is biased by a spring force toward a neutral position and urgable in the first direction. A longitudinal axis of the first module is parallel to a longitudinal axis of the second module in the neutral position. In some implementations, the spring force is caused by a resilient member.

In some implementations, the spring force is a first spring force. The second module is resiliently rotatable relative to the first module such that the second module is biased by a second spring force toward the neutral position and urgable in the second direction. In some implementations, the second spring force is caused by a resilient member.

In some implementations, the frame of the second module is hingedly coupled to the frame of the first module by a hinge joint. In some implementations, the hinge joint defines an opening extending from the first module to the second module.

In some implementations, the system further includes a first tendon guide and a second tendon guide. The first body tendon extends through the first tendon guide and the second body tendon extends through the second tendon guide. In some implementations, a portion of the first body tendon extending from the first tendon guide to the frame of the second module is parallel to a longitudinal axis of the first module when the second module is in a neutral position. A portion of the second body tendon extending from the second tendon guide to the frame of the second module is parallel to the longitudinal axis of the first module when the second module is in the neutral position. The longitudinal axis of the first module is parallel to a longitudinal axis of the second module in the neutral position.

In some implementations, the system further includes a first set of one or more wheels rotatably coupled to the frame of the first module, and a second set of one or more wheels rotatably coupled to the frame of the second module. In some implementations, the first set of one or more wheels rotates about a first wheel rotational axis. The first wheel rotational axis is perpendicular to a longitudinal axis of the first module. The second set of one or more wheels rotates about a second wheel rotational axis. The second wheel rotational axis is perpendicular to a longitudinal axis of the second module.

In some implementations, the system further includes a skin covering the frame, the first body motor, the second body motor, the first spool, and the second spool of both of the first module and the second module. In some implementations, the skin includes a resilient material.

In some implementations, the first module further includes a third body motor, a fourth body motor, a third spool, a fourth spool, a flexible third body tendon, and a flexible fourth body tendon. The third body motor is rigidly coupled to the frame and has a third body shaft that is rotatable about a third body rotational axis. The fourth body motor is rigidly coupled to the frame and has a fourth body shaft that is rotatable about a fourth body rotational axis. The third spool is rigidly coupled to the third body shaft such that rotation of the third body shaft about the third body rotational axis rotates the third spool relative to the frame. The fourth spool is rigidly coupled to the fourth body shaft such that rotation of the fourth body shaft about the fourth body rotational axis rotates the fourth spool relative to the frame. The third body tendon has a first portion and a second portion spaced apart from the first portion. The first portion of the third body tendon is coupled to the third spool such that rotation of the third spool about the third body rotational axis winds the third body tendon about the third spool. The fourth body tendon has a first portion and a second portion spaced apart from the first portion. The first portion of the fourth body tendon is coupled to the fourth spool such that rotation of the fourth spool about the fourth body rotational axis winds the fourth body tendon about the fourth spool. The second portion of the third body tendon and the second portion of the fourth body tendon are coupled to the frame of the second module such that winding of the third body tendon about the third spool causes the second module to rotate relative to the first module in a third direction and winding of the fourth body tendon about the fourth spool causes the second module to rotate relative to the first module in a fourth direction. The third direction is an opposite rotational direction than the fourth direction.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1A is a perspective view of a limbed robotic module, according to one implementation.

FIG. 1B is a top view of the limbed robotic module of FIG. 1A.

FIG. 1C is a perspective view of a limbed robotic system including six-limbed robotic modules of FIG. 1A.

FIG. 2A is an end view of the limbed robotic module of FIG. 1A showing inward leg compliance.

FIG. 2B is a side view of the limbed robotic module of FIG. 1A showing longitudinal knee compliance.

FIG. 2C shows a top view of the limbed robotic module of FIG. 1A showing longitudinal leg compliance.

FIG. 3 is a schematic of the controls for the limbed robotic system of FIG. 1C.

FIG. 4A shows a perspective view of the tracking system setup for evaluating movement of the robots in the study.

FIG. 4B is a perspective view of the limbed robotic system of FIG. 1C with mounted with markers.

FIG. 5 is a schematic view of a traditional serially linked limbless robot of the prior art.

FIG. 6 is a schematic view of a limbless robotic system, according to one implementation.

FIG. 7 is a top view of three limbless robotic modules of the limbless robotic system of FIG. 6.

FIG. 8A shows perspective views of a limbless robotic module of FIG. 7 in various assembled views.

FIG. 8B shows a view of the limbless robotic fully assembled.

FIG. 9 is a perspective view of a limbless robotic module of FIG. 7 with a set of wheels.

FIG. 10 is a top view of the limbless robotic system of FIG. 6 with a skin.

FIG. 11 is a perspective view of a limbless robotic system, according to another implementation.

FIG. 12 is a perspective view of a universal hinge joint of the limbless robotic system of FIG. 11.

FIG. 13 is a rear perspective view of a limbed robotic module, according to another implementation.

FIG. 14 is front perspective view of the limbed robotic module of FIG. 13 with the body motors removed.

### DETAILED DESCRIPTION

The devices, systems, and methods disclosed herein provide for limbed and limbless robots. The robots disclosed herein include modules that, when coupled to each other, form the length of the robot. The modules individually can include means for locomotion and can work together to locomote the entire robotic system.

Some implementations provide for an economically-viable, highly redundant, multilegged, multisegmented robotic device that can be used to locomote effectively in complex terrestrial and aquatic environments. Such mobility can be used for exploration (ocean or space), search and rescue applications, as well as agricultural applications (e.g., to access under brushes for plant monitoring and/or weed removal). The robot can move within confined spaces and over heterogeneous terrain, propelling itself forward, laterally and vertically using combinations of limbs and/or body segments via coordinated stepping and undulation patterns. The device can swim at moderate water depths (in either open water or cluttered situations) using undulatory wave patterns. The device can sense aspects of its environment and use on-board computation to control for diverse locomotory patterns leading to autonomous searching and surveying of environments. The device contains a distributed power system which can be recharged. Some implementations include a series of servo motor body segments plus two limb modules making up the majority of its five to seven body segments. Other modules can be interspersed to provide vertical lift capabilities. Some implementations include passive directional compliance connecting each segment to offload control to mechanics. The robot's non-actuated components are constructed of plastic. The motors and body proprioception feedback sensors are controlled and monitored via a low-cost local microcontroller. Low-cost exteroception sensors (light, temperature, humidity, etc.) can be mounted at the head of the robot or along different segments. Data generated by the device can be recorded in situ for later transmittal or sent to a recording device in real time using telemetry.

Various implementations include a limbed robotic module. The module includes a frame, a first leg motor, a second leg motor, a yoke, and a leg. The first leg motor is rigidly coupled to the frame and has a first leg shaft that is rotatable about a first leg rotational axis. The second leg motor is rigidly coupled to the frame and has a second leg shaft that is rotatable about a second leg rotational axis. The first leg rotational axis is transverse to the second leg rotational axis. The yoke is rigidly coupled to the first leg shaft such that rotation of the first leg shaft about the first leg rotational axis rotates the yoke relative to the frame. The yoke has a shoulder extending radially outwardly from the first leg rotational axis. The leg has a first leg end, a second leg end opposite and spaced apart from the first leg end, and a leg hinge portion disposed between the first leg end and the second leg end. The leg hinge portion is hingedly coupled to the shoulder of the yoke. The first leg end is coupled to the second leg shaft such that rotation of the second leg shaft about the second leg rotational axis rotates the second leg end relative to the yoke.

Various other implementations include a limbed robotic system. The system includes a first module as described above and a second module. The first module is hingedly coupled to the second module.

Various other implementations include a limbless robotic module. The module includes a frame, a first body motor, a first spool, and a second spool. The first body motor is rigidly coupled to the frame and has a first body shaft that is rotatable about a first body rotational axis. The second body motor is rigidly coupled to the frame and has a second body shaft that is rotatable about a second body rotational axis. The first spool is rigidly coupled to the first body shaft such that rotation of the first body shaft about the first body rotational axis rotates the first spool relative to the frame. The second spool is rigidly coupled to the second body shaft such that rotation of the second body shaft about the second body rotational axis rotates the second spool relative to the frame.

Various other implementations include a limbless robotic system. The system includes a first module as described above and a second module. The first module further includes a flexible first body tendon and a flexible second body tendon. The first body tendon has a first portion and a second portion spaced apart from the first portion. The first portion of the first body tendon is coupled to the first spool such that rotation of the first spool about the first body rotational axis winds the first body tendon about the first spool. The second body tendon has a first portion and a second portion spaced apart from the first portion. The first portion of the second body tendon is coupled to the second spool such that rotation of the second spool about the second body rotational axis winds the second body tendon about the second spool. The second module includes a frame. The frame of the second module is hingedly coupled to the frame of the first module. The second portion of the first body tendon and the second portion of the second body tendon are coupled to the frame of the second module such that winding of the first body tendon about the first spool causes the second module to rotate relative to the first module in a first direction and winding of the second body tendon about the second spool causes the second module to rotate relative to the first module in a second direction. The first direction is an opposite rotational direction than the second direction.

### Example Bilaterally-Moving Limbed Robotic System

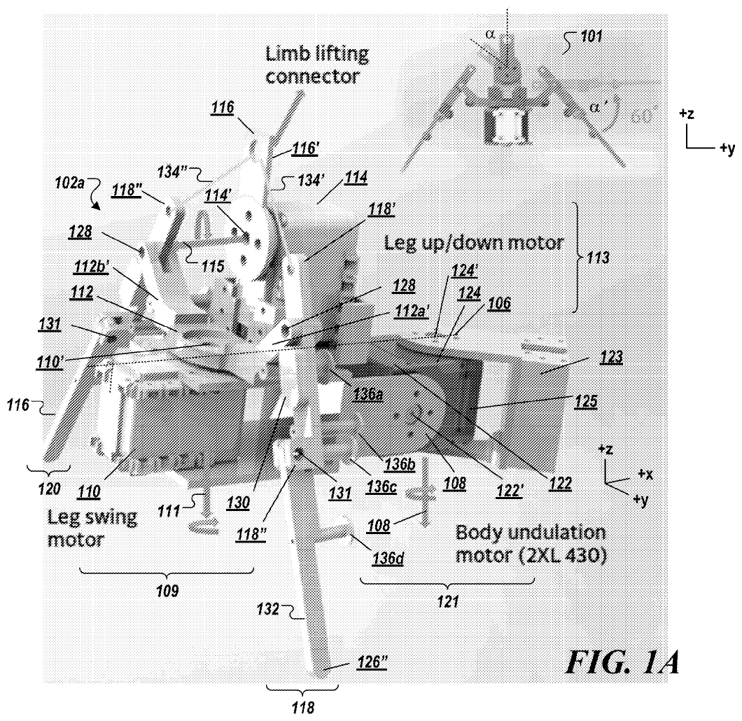

FIGS. 1A, 1B, 1C, 2A, 2B, 3, 4A and 4B show aspects of a limbed robotic system 100, according to aspects of various implementations. In the example shown in FIG. 1C, the system 100 (shown as 100a) includes six modules that are coupled together in which details of an individual module 102 (shown as 102a) are shown in FIGS. 1A and 1B. The number of segments or modules 102 can be adjusted for a given robotic system based on the end-application. In some embodiments, the number of segments is fixed for a closed-design robot system. In other embodiments, the robot system can be configured with an open framework to operate with a base number of segments to which additional segments can be attached.

FIG. 1A shows the limbed robotic module 102 (shown as 102a) that can be connected the same or other like modules to form the system 100 (shown as 100a) in accordance with an illustrative embodiment. The module 102a is defined by a longitudinal axis 106 (located in the X-axis along the center of the module 112a) and includes a frame 108, a first leg motor 110, a yoke 112, a second leg motor 114, an extended linkage 116, a first leg 118, a second leg 120, a first body motor 122, and a second body motor 124.

In the example of FIGS. 1-4, the frame 108 is a three-dimensionally printed PolyLite thermoplastic (Polylactic acid (PLA)). However, in other implementations, the frame can be manufactured in any other configurations and/or of any other material, e.g., having a steel or aluminum alloy body made from casting. The frame 108 is configured as a central supporting structure to which other features of the module 102a can be rigidly mounted. The frame 108 is preferably configured, as shown in FIG. 1A, to be balanced, to include the first leg motor 110 in the rear, the second leg motor 114 in its center with the legs and associated assembly, and the first and second body motors 122 and 124 in the forward region.

First leg hip swing actuation assembly (XY-axis). In FIG. 1A, the frame 108, first leg motor 110, and yoke 112 form a first leg/hip swing actuation assembly 109 that allows the legs to rotate independently of the frame 108, in the XY plane, to provide an independent degree of rotation or control for the module 102a with respect to the overall robot 100a. That is, the frame 108 while remaining in a fixed position with respect to another connected module may have the legs 118, 120 articulate left and right. The first leg motor 110 is rigidly coupled to the frame 108 and has a first leg shaft 110′ (not shown, located in yoke center hole) that is rotatable about a first leg rotational axis 111. The first leg motor 110 is mounted to the frame 108 such that the first leg rotational axis 111 is oriented substantially parallel to a normal axis that is normal to a surface when the module is positioned in an upright position with the legs disposed on the surface. The first leg shaft 110′, extends from the leg motor 110 and coupled to the yoke 112, is configured to be rotated about the first leg rotational axis 111 by a rotational angle of 2θ; that is, at an angle of θ in either direction from a neutral position. In the example shown in FIG. 1A, the module 102a is configured to provide a rotation angle θ up to 70°.

The yoke 112 is rigidly coupled to the first leg shaft 110′ to such that the rotation of the first leg shaft 110′ about the first leg rotational axis 111 rotates the yoke 112 relative to the frame 108. The yoke 112, preferably as a unitary body, has a first shoulder 112a′ extending radially outwardly away from the first leg rotational axis 111 and a second shoulder 112b′ extending radially outwardly away from the first leg rotational axis 111 opposite the first shoulder 112a′.

Second leg lift actuation assembly (Z-axis). The frame 108, second leg motor 114, and extended linkage 116 formed with the yoke 112 form a second leg actuation assembly 113 that allows the legs to move independently of the frame 108, in the z plane, to provide another independent degree of rotation or control for the module 102a with respect to the overall robot 100a. That is, the frame 108 while remaining in a fixed position with respect to another connected module may have the legs 118, 120 articulate up and down (shown as diagram 101). While shown being located on the y-plane in diagram 101, the shoulder 112a′, 112b′ of the yoke 112 may have an angle offset from the y-plane to provide an angle offset to the legs 118, 120.

The second leg motor 114 is rigidly coupled to the frame 108 and has a second leg shaft 114′ (not shown, located in lifting connector center hole) that is rotatable about a second leg rotational axis 115. The second leg motor 114 is mounted to the frame 108 such that the second leg rotational axis 115 is perpendicular to the first leg rotational axis 111 and parallel to the longitudinal axis 106 of the module 102a. However, in some implementations, the second leg rotational axis 115 is transverse to the first leg rotational axis 111; that is, the second leg motor 114 may be coupled to the frame 108 with an angle such that the second leg rotational axis 115 is angled with respect to the longitudinal axis 106. The second leg shaft 114′ is configured to rotate about the second leg rotational axis 115 by a rotational angle of a from a neutral position. The rotation of the second leg shaft 114′ by rotation angle α can produce an angle α′ at the legs due to the linkage configuration of the legs 118, 120 with the yoke 112.

In the example shown in FIGS. 1-4, both of the first leg motor 110 and the second leg motor 114 are servo motors, but in other implementations, the first leg motor 110 and the second leg motor 114 can be other actuation devices, including geared DC motors, linear actuators, capable of causing rotational movement of their respective shaft about their respective rotational axis.

The extended linkage 116 (shown as “Limb lifting connector”) is rigidly coupled to the second leg shaft 114′ such that rotation of the second leg shaft 114′ about the second leg rotational axis 115 causes the extended linkage 116 to rotate about the second leg rotational axis 115 relative to the frame 108. The extended linkage 116 has a protrusion region 116′ extending radially outwardly from the second leg rotational axis 115.

Leg assembly. Each of the first leg 118 and the second leg 120 have a first leg end 118′, a second leg end 118″ opposite and spaced apart from the first leg end 118′, and a leg hinge portion 128 disposed between the first leg end 118′ and the second leg end 118″. Each of the legs 118, 120 includes (i) a first leg segment 130 that includes the first leg end 126′ and (ii) a second leg segment 132 that couples, via hinge portion 131, to the first leg segment 130 at the second leg end 118″.

The leg hinge portion 128 of the first leg 118 is hingedly coupled to the first shoulder 112a′ of the yoke 112, and the leg hinge portion 128 of the second leg 120 is hingedly coupled to the second shoulder 112b′ of the yoke 112. To this end, the first leg/hip swing actuation assembly 109 can cause a rotation of the first leg shaft 110′ of the first leg motor 110 about the first leg rotational axis 111 to cause rotation of the yoke 112 about the first leg rotational axis 111, which cause a rotation of the legs 118, 120 about the first leg rotational axis 111. As the legs 118, 120 move in rotation about the first leg rotational axis 111, the first leg segment 130 of the first leg 118 and the first leg segment 130 of the second leg 120 alternatively move between anterior and posterior positions relative to the longitudinal axis 106 of the module 102a.

Legs and Hips movement. A flexible first leg tendon 134 (shown as 134′) extends between the protrusion 116′ of the extended linkage 116 and the first leg end 118′ of the first leg 118. As used here, the term “tendon” refers to any soft but non-extendable connection component or rigid component that transfers forces from one component to another component. A flexible second leg tendon 134 (shown as 134″) extends between the protrusion 116′ of the extended linkage 116 and the first leg end 118″ of the second leg 120. Thus, rotation of the second leg shaft 114′ of the second leg motor 114 about the second leg rotational axis 115 in a first direction (e.g., clockwise in the +y direction, e.g., as shown in diagram 101) causes a rotation of the protrusion 116′ of the extended linkage 116 about the second leg rotational axis 115 in the first direction, which pulls the first leg tendon 134′ and the first leg end 118′ of the first leg 118 in the first direction and causes the rotation of the first leg 118 about the leg hinge portion 128 and the first shoulder 112′ of the yoke 112. Furthermore, rotation of the second leg shaft 114′ of the second leg motor 114 about the second leg rotational axis 115 in a second direction (e.g., counter-clockwise in the +y direction) causes rotation of the protrusion 116′ of the extended linkage 116 about the second leg rotational axis 115 in the second direction, which pulls the second leg tendon 134″ and the first leg end 118″ of the second leg 120 in the second direction and causes rotation of the second leg 120 about the leg hinge portion 128 of the second leg 120 and the second shoulder 112′ of the yoke 112. Each of the first leg 118 and the second leg 120 can be rotated up to 90 degrees from the normal axis (e.g., in the XZ plane). For the implementation shown in FIGS. 1A-4B, the neutral position of the first leg and the second leg are 30 degrees from the normal axis. Thus, the first leg and the second leg are rotatable 60 degrees from their neutral positions.

### Passive Control Elements

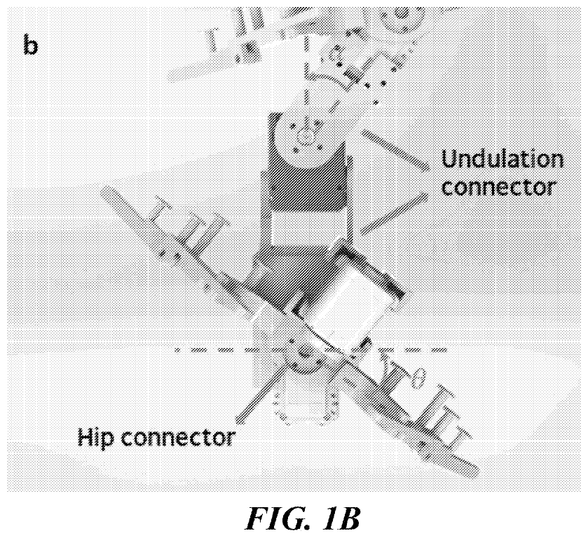

The yoke 112, first leg segment 130, and the second leg segment 132 includes a set of anchors 136 (shown as 136a, 136b, 136c, and 136d) to which a shoulder resilient member (not shown—see FIGS. 2A-2C) and a knee resilient member (not shown—see FIGS. 2A-2C) can attached. The shoulder resilient member is configured to pull, as a passive control element, the first leg segment 130 to its neutral position from an extended position resulting from the second leg actuation assembly. The knee resilient member is configured to pull, as another passive control element, the second leg segment 132 to its neural position with the first leg segment 130. The first leg segment 130 and the second leg segment 132 may be biased to rotate at the hinge portion 131 in only one direction.

In the example shown in FIG. 2A, the module 102 (shown as 102a′ and 102b′) includes a first shoulder resilient member 202′ that couples the anchor 136a located proximal to the first shoulder 112a′ of the yoke 112 to the anchor 136b of the first leg 118. The first shoulder resilient member 202′ is configured to cause the leg hinge portion 128 of the first leg 118 to be resiliently rotatable relative to the first shoulder 112a′ of the yoke 112 such that the first leg 118 is biased by the first shoulder resilient member 202′ toward the first shoulder position (the neutral position). Similarly, the module 102a′ and 102b′ further includes a second shoulder resilient member 202″ that couples the anchor 136a located proximal to the second shoulder 112b′ of the yoke 112 to the anchor 136b of the second leg 120. The second shoulder resilient member 202″ is configured to cause the leg hinge portion 128 of the second leg 120 to be resiliently rotatable relative to the second shoulder 112b′ of the yoke 112 such that the second leg 120 is biased by the second shoulder resilient member 202″ toward a first shoulder position (the neutral position). In the example shown in FIG. 2A-2C, it can be observed that the neural position of the legs 118, 120 are defined by the length and elastic properties of the first shoulder resilient member 202′.

The combination of the forces created by the rotation of the protrusion 116′ of the extended linkage 116 about the second leg rotational axis 115 to pull the tendons 134′ and 134″, the extension of the first shoulder resilient member 202′, the extension of the second shoulder resilient member 202″, and the geometry of the linkages formed by the legs 118, 120 and the yoke 112 cause the first leg 118 and the second leg 120 to alternate moving between raised and lowered positions relative to the normal axis.

In the example shown in FIGS. 2A-2C, the module 102a′ and 120b′ also includes a first knee resilient member 204′ that couples the first leg segment 130 (at anchor 136c) of the first leg 118 to the second leg segment 132 (at anchor 136d) of the first leg 118. The first knee resilient member 204′ causes the second leg segment 132 of the first leg 118 to be resiliently rotatable relative to the first leg segment 130 of the first leg 118 such that the second leg segment 132 is biased by the first knee resilient member 204′ toward a first leg position (the neutral position).

The module further includes a second knee resilient member 204″ that couples the first leg segment 130 (at anchor 136c) of the second leg 120 to the second leg segment 132 (at anchor 136d) of the second leg 120. The second knee resilient member 204″ causes the second leg segment 132 of the second leg 120 to be resiliently rotatable relative to the first leg segment 130 of the second leg 120 such that the second leg segment 132 is biased by the second knee resilient member 204″ toward a first leg position (the neutral position).

The first knee resilient member 204′ and the second knee resilient member 204″ allow the second leg segment 132 of the first leg 118 and the second leg segment 132 of the second leg 120, respectively, to bend if the leg is obstructed by an object during a step. The bent leg can pass over the object and straighten back to the neutral position once the leg has passed over the object. The passive control elements provided by the shoulder resilient members 202 and the knee resilient members 204 provide additional mechanism and/or degree of freedom for control that does not require active control signaling or motors.

FIG. 2C shows an implementation with a third passive control of longitudinal leg compliance. The frame 108 includes an additional set of anchors 136e to which a third resilient member 206 can attached, along with attaching to the to the anchor 136a. The third resilient member is configured to pull, as a passive control element, the first leg segment 130 longitudinally to its neutral position from a longitudinally retracted position resulting from the leg assembly being forced to rotate longitudinally posteriorly and laterally inwardly. This passive control of the third passive control of longitudinal leg compliance allows the leg assembly to be forced inwardly and rearwardly by obstacles as the system moves by the obstacle, but then return to the neutral position of the leg assembly once the leg assembly has passed by the obstacle.

Although the first shoulder resilient member 202′, the second shoulder resilient member 202″, the first knee resilient member 204′, and the second knee resilient member 204″ shown in FIGS. 1A-4B are all rubber bands, in other implementations, the first shoulder resilient member, the second shoulder resilient member, the first knee resilient member 204′, and the second knee resilient member 204″ are elastic bands springs, or any other device capable of creating a spring or compressive force.

Inter-module body movement. The frame 108 of each module 102 includes one or more body motors form a body actuation assembly 121 that can provide XY-plane rotation and/or XZ-plane rotation between connecting modules 102. In the example shown in FIG. 2A, the frame 108 includes (i) the first body motor 122 that can facilitate movement in the XY-plane and (ii) the second body motor 124 that can facilitate movement in the XZ-plane.

In some embodiments, including those shown in FIGS. 1A-1C and 2A-2C, the first body motor 122 and the second body motor 124 are disposed within the same body motor housing 125 such that the motors are rigidly coupled to each other.

The first body motor 122 is coupled to the frame 108 of the module 102a and has a first body shaft 122′ that is rotatable about a first body rotational axis (XZ-plane). The adjacent module 102b is rigidly coupled, via link 123 and body motor housing 125, to the first body shaft 122′ such that rotation of the first body shaft 122′ about the first body rotational axis rotates the adjacent module 102b relative to the module 102a. The first body motor 122 is oriented (in the neutral position) such that the first body rotational axis is parallel to the normal axis such that the rotation of the first body shaft 122′ rotates the adjacent module 102b laterally with respect to the module 102a and the normal axis.

The second body motor 124 is coupled to the frame 108 of the module 102a and has a second body shaft 124′ that is rotatable about a second body rotational axis 138. The frame 108 of the module 102a is rigidly coupled to the second body shaft 124′ such that rotation of the second body shaft 124′ about the second body rotational axis 138 rotates the second body motor 124 relative to the frame 108 of the module 102a. The second body motor 124 is oriented such that the second body rotational axis 138 is perpendicular to the first body rotational axis (along the XZ-plane) such that the rotation of the second body shaft 124′ rotates the adjacent module 102b horizontally with respect to the module 102a and the normal axis.

The combination of the first body motor 122 and the second body motor 124 coupling the module 102a to an adjacent module 102b allow the system 100 to undulate along the modules as the system moves.

Both of the first body motor 122 and the second body motor 124 shown in FIGS. 1A-4B are servo motors, but in other implementations, the first body motor 122 and the second body motor 124 are any actuation device, including geared DC motors, linear actuators, capable of causing rotational movement of their respective shaft about their respective rotational axis.

Although the system shown in FIGS. 1A-1C includes six modules and in FIGS. 2A-2B includes two modules, in other implementations, the system can include any number of two or more modules, including 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50. In some embodiments, the number of modules may be greater than 50 and less than 100. In some implementations, the system can also include other types of modules other than the modules shown in FIGS. 1A-4B, such as a head, a tail, or modules with other functionality such as grasping (including a grasper), cutting (including a cutter), imaging (including an optical sensor), or spraying (including a sprayer).

### Example Bilaterally-Moving Limbless Robotic System

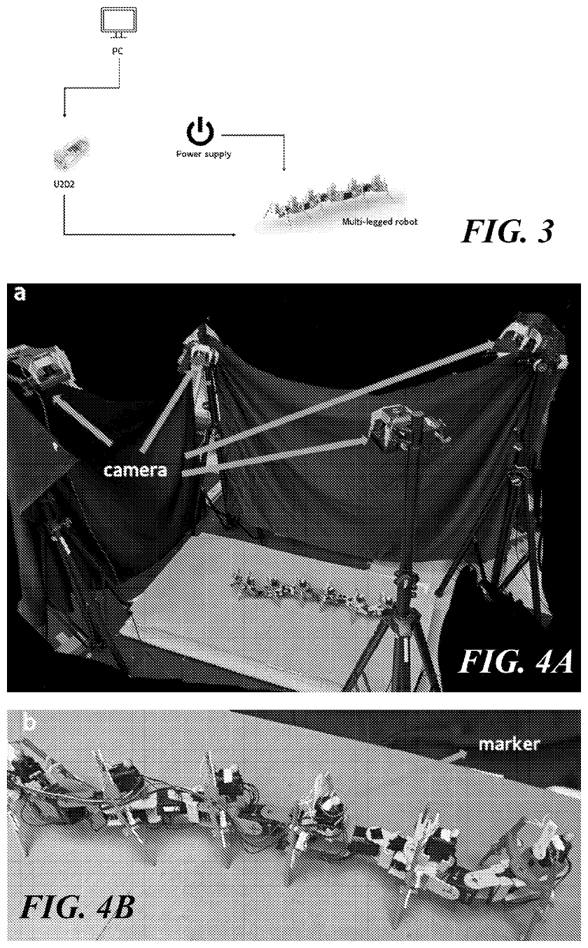

FIGS. 6-12 show a limbless robotic system, according to aspects of various implementations. As seen in FIG. 6, the system includes five modules 702 and a head module 704 that are coupled together.

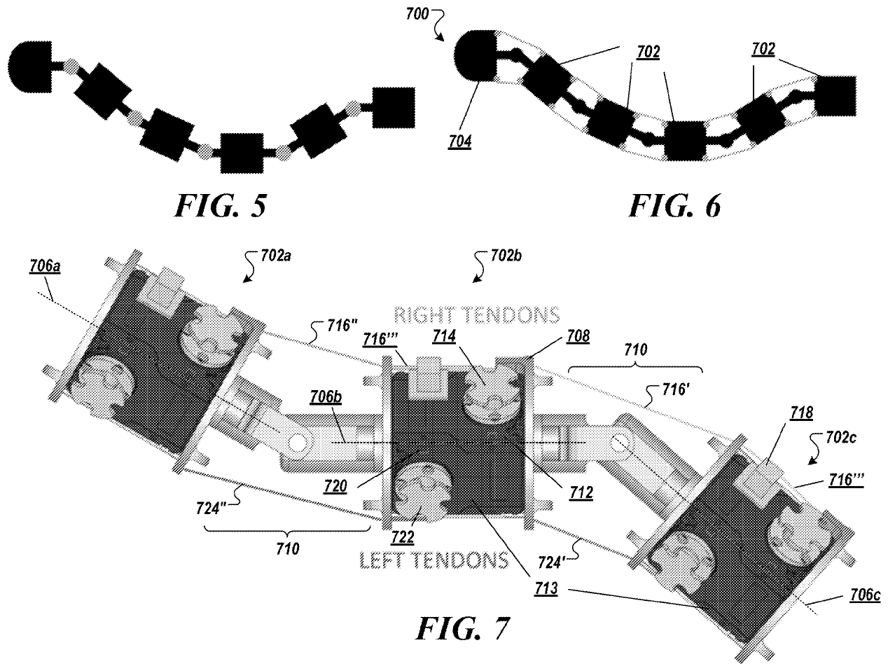

FIG. 7 shows three modules 702 (shown as 702a, 702b, and 702c) of the limbless robotic modules 702 of the system 700 shown in FIG. 6. Each module 702 is defined by a longitudinal axis 706 and includes a frame 708, a hinge joint 710, a first body motor 712, a first spool 714, a first body tendon 716, a first tendon guide 718, a second body motor 720, a second spool 722, a second body tendon 724, a second tendon guide 726. The modules 702 may further include a first set of wheels 728 and a skin 730.

The frame 708 shown in FIGS. 7-9 is a three-dimensionally printed PolyLite PLA, however in other implementations, the frame can be manufactured in any other configurations and/or of any other material, e.g., having a steel or aluminum alloy body made from casting. The frame is configured such that the other features of the module can be rigidly mounted to the frame.

In the example of FIG. 7, the frame 708 of each of the modules 702 (shown as 702b) is hingedly coupled to the frame 708 of an adjacent module (shown as 702a and 702c) by a hinge joint 710. The hinge joint 710 has a hinge axis of rotation that is parallel to the normal axis such that rotation about the hinge axis causes the adjacent module 702a, 702c to rotate laterally with respect to the module 702b and the normal axis.

The hinge joint 710 defines an opening extending from the module 702b to the adjacent module 702a, 702c. Power and communication wires from the body motors 712, 720 of the module 702b extend through the opening to the body motors 712, 720 of the adjacent module 702a, 702c to wire the body motors 712, 720 in a daisy-chain series.

The first body motor 712 and the second body motor 720 are disposed within the same body motor housing 713 such that the motors 712, 720 are rigidly coupled to each other. In other implementations, the first body motor and the second body motor can each be servo motors.

The first body motor 712 is rigidly coupled to the frame 708 by the body motor housing 713 and has a first body shaft 714′ that is rotatable about a first body rotational axis. The first body motor 712 is mounted to the frame 708 such that the first body rotational axis is oriented substantially at a 45-degree angle to the normal axis and perpendicular to the longitudinal axis 706b when the module 702 is positioned in an upright position with the wheels 728 disposed on the surface.

The first spool 714 (e.g., pulley) is rigidly coupled to the first body shaft 714′ (connecting the first spool 714 and the first body motor 712) such that rotation of the first body shaft 714′ about the first body rotational axis rotates the first spool 714 relative to the frame 708.

The first body tendon 716″ has a first portion and a second portion spaced apart from the first portion. The first portion of the first body tendon 716″ is coupled to the first spool 714 such that rotation of the first spool 714 about the first body rotational axis winds the first body tendon 716″ about the first spool 714.

The second portion of the first body tendon 716″ is coupled to a portion (e.g., first tendon guide 718) of the frame 708 of the adjacent module 702a, 702c located off center of the hinge joint 710 such that winding of the first body tendon 716″ about the first spool 714 causes the adjacent module (e.g., 702c) to rotate relative to the module 702b in a first direction about the hinge rotational axis of the hinge joint 710.

The first tendon guide 718 is coupled directly to the body motor housing 713 of each respective module 702a, 702b, 702c. The first body tendon 716″ extends through the first tendon guide 718 such that a portion of the first body tendon 716″ extending from the first tendon guide 718 to the frame 708 of the adjacent module 702a, 702c is parallel to a longitudinal axis 706b of the module 702b when the adjacent module 702a, 702c is in a neutral position in which the longitudinal axis 706 (shown as 706b) of the module 702b is parallel to a longitudinal axis 706 (shown as 706a, 706c) of the adjacent module 702a, 702c.

The second body motor 720 is also rigidly coupled to the frame 708 by the body motor housing 713 and has a second body shaft 720′ that is rotatable about a second body rotational axis. The second body motor 720 is mounted to the frame 708 such that the second body rotational axis is oriented substantially at a 45-degree angle to the normal axis, perpendicular to the longitudinal axis 706b, and perpendicular to the first body rotational axis when the module 702 is positioned in an upright position with the wheels 728 disposed on the surface.

The second spool 722 is rigidly coupled to the second body shaft 722′ such that rotation of the second body shaft 722′ about second body rotational axis rotates the second spool 722 relative to the frame 708.

The second body tendon 724″ has a first portion and a second portion spaced apart from the first portion. The first portion of the second body tendon 724″ is coupled to the second spool 724 such that rotation of the second spool 724 about the second body rotational axis winds the second body tendon 724″ about the second spool 724.

The second portion of the second body tendon 724″ is coupled to a portion (e.g., second tendon guide 726) of the frame 708 of the adjacent module 702a, 702c off-center of the hinge joint 710 and opposite the portion of the frame 708 to which the second portion of the first body tendon 716″ is coupled such that winding of the second body tendon 724″ about the second spool 722 causes the adjacent module 702a, 702c to rotate relative to the module 702b in a second direction about the hinge rotational axis. The first direction is an opposite rotational direction than the second direction.

The second tendon guide 726 is coupled directly to the body motor housing. The second body tendon 724″ extends through the second tendon guide 726 such that a portion of the second body tendon 724″ extending from the second tendon guide 726 to the frame 708 of the adjacent module 702a, 702c is parallel to a longitudinal axis 706b of the module 702b when the adjacent module 702a, 702c is in the neutral position.

Both of the first body motor 712 and the second body motor 720 shown in FIGS. 7-9 are servo motors, but in other implementations, the first body motor 712 and the second body motor 720 are any actuation device, including geared DC motors, linear actuators, capable of causing rotational movement of their respective shaft about their respective rotational axis.

Although the first body rotational axis and the second body rotational axis shown in FIGS. 7-9 are oriented such that they are perpendicular to each other, in some implementations, the first body rotational axis and the second body rotational axis are oriented in any way that allow a tendon to be extended on either side of a hinge joint of an adjacent module.

The first spool 714 and the second spool shown in FIGS. 7-9 are pulleys, in some implementations, the first spool 714 and the second spool can be any shape such that tendons can be wound around them as the first spool 714 and the second spool are rotated.

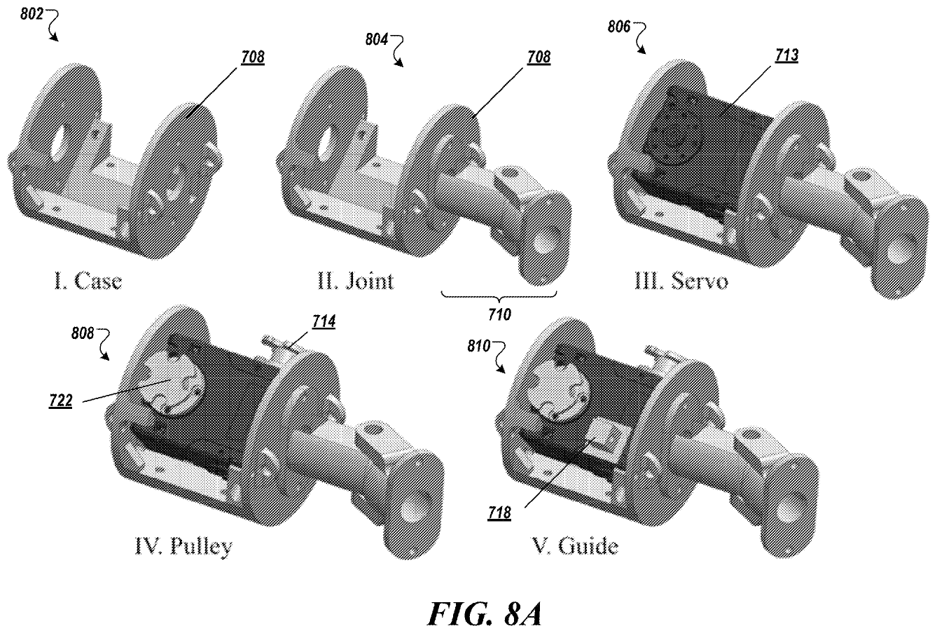

FIG. 8A shows perspective views of a limbless robotic module of FIG. 7 in various assembled views. FIG. 8B shows a view of the limbless robotic fully assembled. View 802 of FIG. 8 shows the frame 708. View 804 shows the frame 708 coupled to the hinge joint 710. View 806 additionally shows the body motor housing 713 comprising the first body motor 712 and the second body motor 720. View 808 additionally shows the first spool 714 and the second spool 722 coupled to the respective first body motor 712 and the second body motor 720. View 808 additionally shows the first tendon guide 718 (the assembly includes a second tendon guide, not shown).

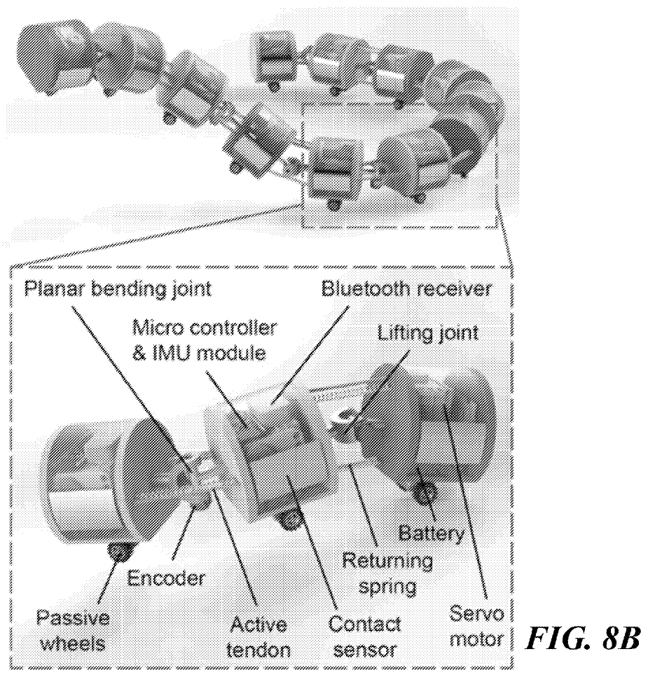

Wheels. FIG. 9 is a perspective view of a limbless robotic module of FIG. 7 with a set of wheels (optional). In some embodiments, the set of wheels 728 shown in FIG. 9 are rotatably coupled to the frame 708 of the module 702. The set of wheels 728 includes, in some embodiments, two wheels 728 that are rotatable about a common wheel rotational axis. The wheel rotational axis is perpendicular to the longitudinal axis 706b of the module, which allows the module 702 to move along the longitudinal axis 706b with low friction but resist movement in the lateral direction due to the friction of the wheel material (e.g., rubber). This anisotropy aids in limbless locomotion, especially on surfaces with low friction.

Although the module 702 shown in FIG. 9 includes one set of wheels 728, in some implementations, the module 702 includes two or more sets of wheels 728. The set of wheels 728 in FIG. 9 includes two wheels 728 in the set of wheels, but in some implementations, the set of wheels includes one wheel or two or more wheels.

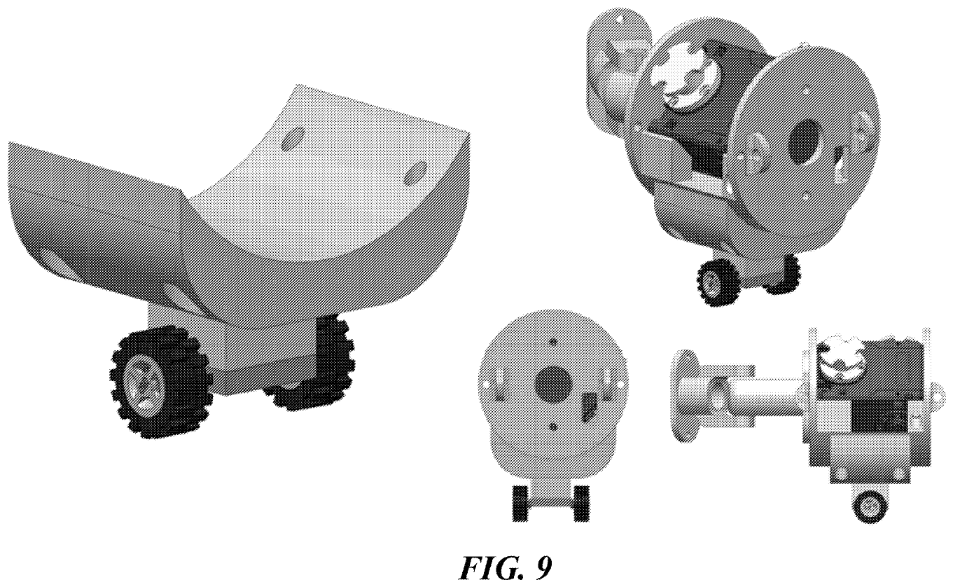

Skin. FIG. 10 shows the system 700 of FIG. 7-8 with a skin covering 730. In the example, the skin covering 730 encapsulates the frame 708, the first body motor 712, the second body motor 720, the first spool 714, and the second spool 722 of each of the modules 702 in the system 700. The skin 730 includes a resilient material which aids in the locomotion of the system.

The resilient skin 730 causes an adjacent module (e.g., 702a, 702c) to be resiliently rotatable relative to a module (e.g., 702b) such that the adjacent module (e.g., 702a, 702c) is biased by the spring force of the skin 730 toward a neutral position and urgable in the first direction or the second direction. Thus, after the first body tendon 716″ or the second body tendon 724″ are wound around the first spool 714 or the second spool 722, respectively, the skin 730 can urge the adjacent module (e.g., 702a, 702c) to rotate in the first direction or the second direction. And when the first body motor 122 or the second body motor 720 has released the tension on their respective spools 714, 722, the skin 730 acts as a resilient member to passively bias the adjacent module 702a, 702c back to the neutral position.

The skin 730 also helps protect the other features of the system from the environment.

Although the system shown in FIG. 10 includes a skin 730, in some implementations, one or more of the modules 702 is not covered in a skin 730. In some implementations in which a resilient skin 730 does not cover adjacent modules, one or more resilient members (e.g., 202) may be employed to couple the module 702 to the adjacent modules to passively bias the adjacent module back to the neutral position. In some implementations, the system includes a skin 730 that is not resilient.

### Another Example Bilaterally-Moving Limbless Robotic System

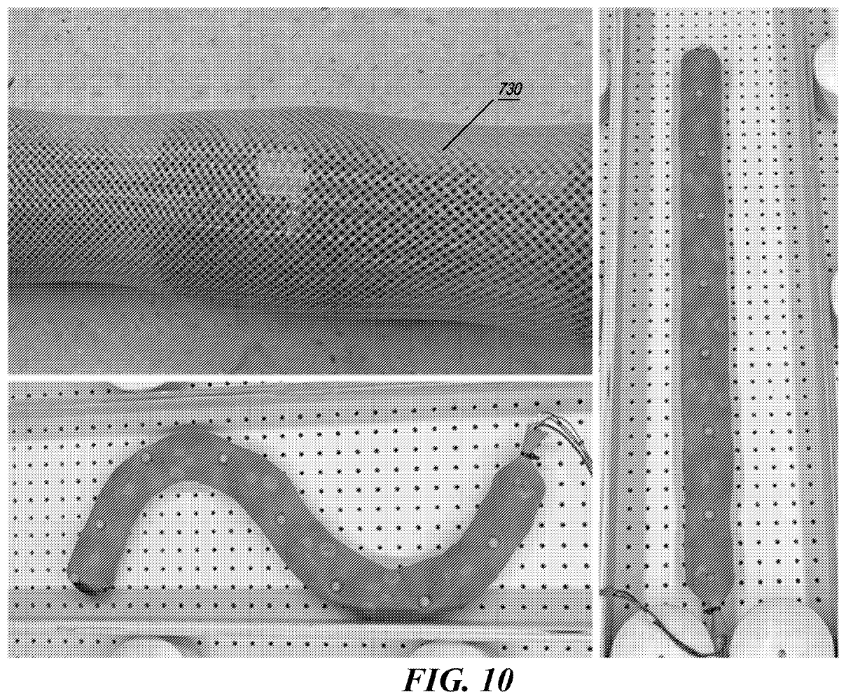

Quad-lateral-Motor Modules. FIG. 11 shows another limbless system 1100 configured with quad-lateral motor modules 1102 (shown as 1102a, 1102b), according to aspects of various implementations. The system shown in FIG. 11 is similar to the system shown in FIGS. 6-10 in that each module 1102 includes a longitudinal axis 706, a frame 708, a first body motor 712, a first spool 714, a first body tendon 716, a second body motor 720, a second spool 722, and a second body tendon 724. However, the modules 1102 shown in FIG. 11 include a universal hinge joint 1104, a third body motor 1106, a third spool 1108, a third body tendon 1110, a fourth body motor 1112, a fourth spool 1114, and a fourth body tendon 1116.

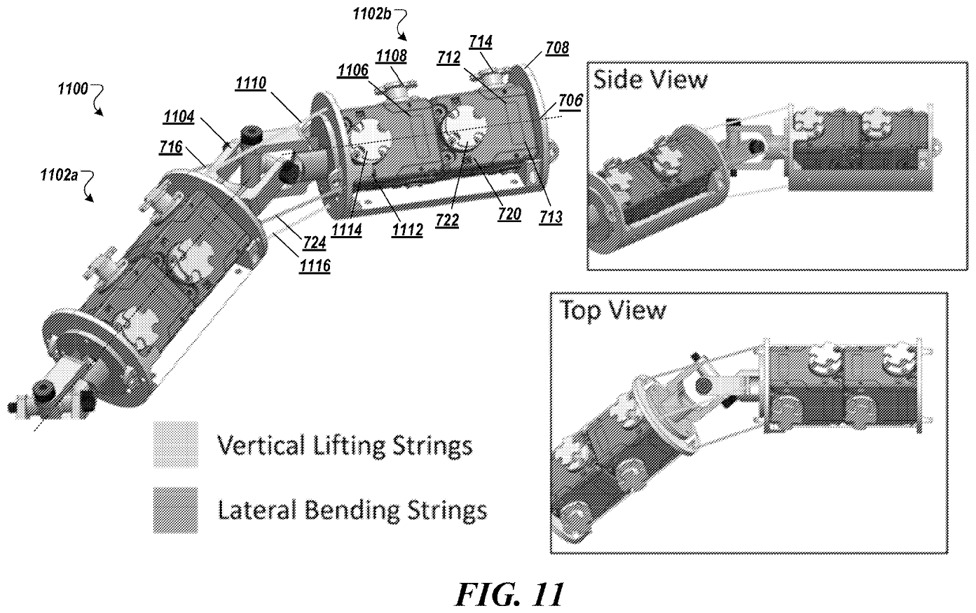

The frame 708 of each of the modules 1002 (shown as 1002a) is hingedly coupled to the frame 708 of an adjacent module 1002 (shown as 1002b) by the universal hinge joint 1104, shown in FIG. 12. The universal hinge joint 1104 has a first hinge axis of rotation that is parallel to the normal axis such that rotation about the hinge axis causes the adjacent module to rotate laterally with respect to the module and the normal axis. The universal hinge joint 1104 further has a second hinge axis of rotation that is perpendicular to the normal axis such that rotation about the second hinge axis causes the adjacent module to rotate vertically with respect to the module and the normal axis.

The third body motor 1106 and the fourth body motor 1112 may be disposed within the same body motor housing 713 as the first body motor 712 and the second body motor 720 such that the motors are rigidly coupled to each other. In other embodiments, the third body motor 1106 and the fourth body motor 1112 are disposed in a different body motor housing that is coupled to the body motor housing 713 of the first body motor 712 and the second body motor 720.

The third body motor 1106 is rigidly coupled to the frame 708 by the body motor housing 713 and has a third body shaft 1106′ that is rotatable about a third body rotational axis. The third body motor 1106 is mounted to the frame 708 such that the third body rotational axis is oriented substantially at a 45-degree angle to the normal axis, perpendicular to the longitudinal axis 706, perpendicular to the second body rotational axis, and parallel to the first body rotational axis when the module is positioned in an upright position.

The third spool 1108 is rigidly coupled to the third body shaft 1106′ such that rotation of the third body shaft 1106′ about the third body rotational axis rotates the third spool 1108 relative to the frame.

The third body tendon 1110 has a first portion and a second portion spaced apart from the first portion. The first portion of the third body tendon is coupled to the third spool 1108 such that rotation of the third spool 1108 about the third body rotational axis winds the third body tendon 1110 about the third spool 1108.

The second portion of the third body tendon 1110 is coupled to a portion of the frame 708 of the adjacent module 1102b located off center of the universal hinge joint 1104 such that winding of the third body tendon 1110 about the third spool 1108 causes the adjacent module 1102a to rotate relative to the module 1102b in a third direction about the second hinge rotational axis.

The fourth body motor 1112 is also rigidly coupled to the frame 708 by the body motor housing 713 and has a fourth body shaft 1112′ that is rotatable about a fourth body rotational axis. The fourth body motor 1112 is mounted to the frame 708 such that the fourth body rotational axis is oriented substantially at a 45-degree angle to the normal axis, perpendicular to the longitudinal axis 706, perpendicular to the first body rotational axis and the third body rotational axis, and parallel to the second body rotational axis when the module is positioned in an upright position.

The fourth spool 1114 is rigidly coupled to the fourth body shaft 1112′ such that rotation of the fourth body shaft 1112′ about fourth body rotational axis rotates the fourth spool 1114 relative to the frame 708.

The fourth body tendon 1116 has a first portion and a second portion spaced apart from the first portion. The first portion of the fourth body tendon 1116 is coupled to the fourth spool 1114 such that rotation of the fourth spool 1114 about the fourth body rotational axis winds the fourth body tendon 1116 about the fourth spool 1114.

The fourth portion of the fourth body tendon 1116 is coupled to a portion (e.g., guide) of the frame 708 of the adjacent module (e.g., 1002a) off-center of the universal hinge joint 1104 and opposite the portion of the frame 708 to which the second portion of the third body tendon 1110 is coupled such that winding of the fourth body tendon 1116 about the fourth spool 1114 causes the adjacent module (e.g., 1102a) to rotate relative to the module (e.g., 1102b) in a fourth direction about the second hinge rotational axis. The third direction is an opposite rotational direction than the fourth direction.

In some implementations, each module 1102 of the system includes a first tendon guide 718, a second tendon guide 726, a third tendon guide, and a fourth tendon guide through which the first body tendon, the second body tendon 724, the third body tendon, and the fourth body tendon extend as described above with respect to the tendon guides of FIGS. 6-10.

Each of the first body motor, the second body motor, the third body motor, and the fourth body motor shown in FIG. 11 are servo motors, but in other implementations, the first body motor 712, the second body motor 720, the third body motor 1106, and the fourth body motor 1112a are any actuation device capable of causing rotational movement of their respective shaft about their respective rotational axis.

Although the first body rotational axis, the second body rotational axis, the third body rotational axis, and the fourth body rotational axis shown in FIG. 11 are oriented such that they are perpendicular to each other, in some implementations, the first body rotational axis, the second body rotational axis, the third body rotational axis, and the fourth body rotational axis may be oriented in any way that allows a tendon to be extended on either side of a universal hinge joint of an adjacent module.

The first spool 714, the second spool 722, the third spool, and the fourth spool shown in FIG. 11 are pulleys, in some implementations, the first spool 714, the second spool 722, the third spool, and the fourth spool can be any shape such that tendons can be wound around them as the first spool 714 and the second spool 722 are rotated.

Although the module shown in FIG. 11 does not include any sets of wheels, in some implementations, the modules can include sets of wheels as described above with regards to the modules shown in FIGS. 6-10. Although the system shown in FIG. 11 does not include a skin, in some implementations, the system can include a skin, as described above with regards to the system shown in FIGS. 6-10.

### Another Example Bilaterally-Moving Limbed Robotic System

It is fully intended that the locomotive mechanisms for the body and other features described for the limbless systems and modules herein can be incorporated into the limbed systems and modules described herein. For example, the spool mechanisms for the bilaterally-movement robot may be employed for in-plane movements of the limbed system. Similarly, it is fully intended that the locomotive mechanisms for the legs and other features described for the limbed systems and modules herein can be incorporated into the limbless systems and modules described herein.

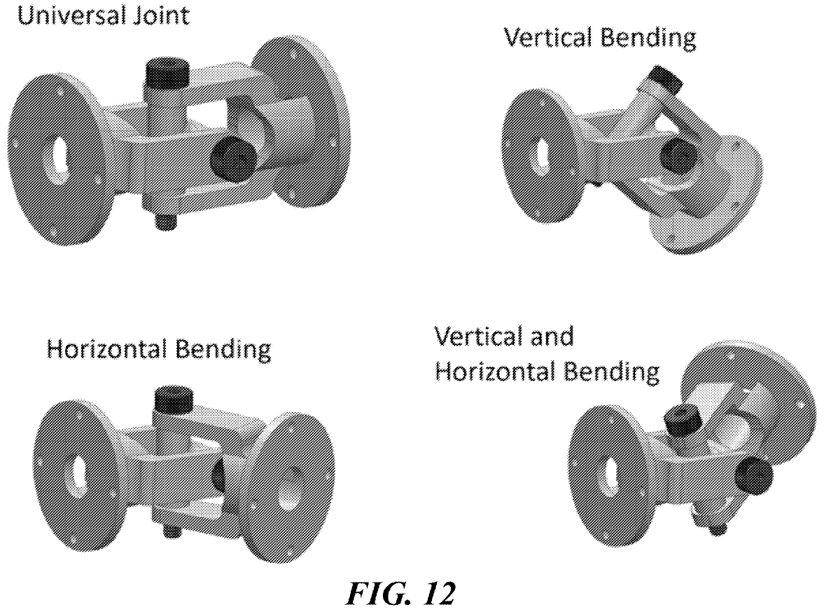

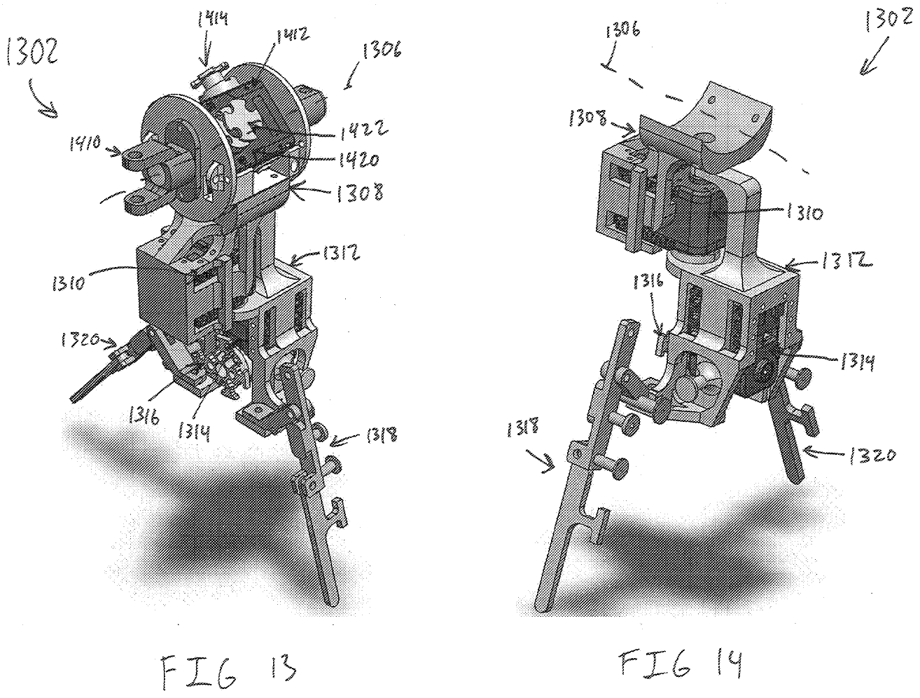

For example, FIGS. 13 and 14 show a limbed robotic module 1302 including similar leg locomotion features as those described with respect to FIGS. 1A-4B and similar body locomotion features as those described with respect to FIGS. 6-8. However, the frame 1308 shown in FIGS. 13 and 14 has been reconfigured to reduce the overall length on the module 1302 in the longitudinal direction.

The module 1302 shown in FIGS. 13 and 14 includes a longitudinal axis 1306, a frame 1308, a hinge joint 1410, a first leg motor 1310, a yoke 1312, a second leg motor 1314, an extended linkage 1316, a first leg 1318, a second leg 1320, a first body motor 1412, a first spool 1414, a second body motor 1420, and a second spool 1422.

The frame 1308 in FIGS. 13 and 14 is reconfigured such that the first body motor 1416 and second body motor 1420 are disposed above both the first leg motor 1310 and second leg motor 1314 and with the first leg motor 1310 disposed above the second leg motor 1314 when the module 1302 is positioned in an upright position. However, because the axes of rotation of each of the first leg motor 1310, the second leg motor 1314, the first body motor 1416, and the second body motor 1420 are all oriented in the same way as in the implementations shown in FIGS. 1A-4B and 6-8, each of the motors still perform the same function in the same way as the other implementations described herein.

Although the system shown in FIGS. 6-12 includes five modules and a head, in other implementations, the system can include any number of two or more modules. In some implementations, the system can also include other types of modules other than the modules shown in FIGS. 6-12, such as modules with other functionality such as grasping, cutting, or spraying.

### EXPERIMENTAL RESULTS AND ADDITIONAL EXAMPLES

A study was conducted to evaluate various embodiments of the limbed and limbless robots.

Limbed robot study. In the portion of the study evaluating the limbed robot, the study built a multi-legged robotic system. The robot was 3D-printed by Taz Workhorse and the printing material is PolyLite PLA. AX-12A and 2XL430-W250 motors control body undulation and limb retraction/protraction. The overall robot was composed of multiple repeating modules (e.g., as shown in FIG. 1a). Each module had three degrees of freedom (DoF): the shoulder lifting joint that controlled the contact states of contralateral legs, the shoulder retraction joint that controlled the fore/aft positions of leg movements, and the body bending joint that controlled the lateral body undulation. Specifically, a leg up/down servo motor and a leg swing motor controlled the limb stepping and were connected by a hip connector (FIG. 1B).

Those limb motors were connected with a body undulation motor with a undulation connector. The limb lifting connector which contained fishing lines (yellow lines in FIG. 1A) connected the up/down motor and legs. Each leg was hinged to the hip connector using a rigid DoF revolute joint whose rotation axis is parallel to the fore-aft direction. The legs could lift up to 60° from their neutral position, which corresponded to maximum lift, about 7 cm above the ground. The leg lifting angles could be modulated by controlling the up/down motor. The leg swing angle θ and the lateral body angle α were actively controlled by a leg swing motor and a body undulation motor (FIG. 1B).

This modular design allowed the study to readily change the number of the modules (and legs) of the robot. The study performed experimental verification of a prediction model by changing modules of the robophysical model (3 to 8 modules corresponding to 6 to 16-legged robotics system).

Limbless Robot Study. The study also evaluates the fundamental components of limbless robots. To assemble most limbless robots, the individual modules were attached to one another, forming a “chain” of modules that are each individually controlled to allow for different body shapes. One design included 8 linked modules.

The study used active tendons that run along both edges of the modules. Each tendon was independently controlled using a pulley mechanism attached to a servo motor. These tendons closely mimicked the musculature of animals such as snakes. Compared to traditional “serially-linked” actuation that happens at the joint, the new actuation method not only more closely mimics the way the animals but has allowed the study to develop new control strategies that have inherent passiveness which has proven beneficial in not only traversing more difficult terrains but also improving limbless robot efficiency.

The overall design in the study was made of multiple components that collectively formed a chain of linked modules. Each individual module included 2 servo motors housed inside of a case. Cases were attached to one another using single joints. Then, small pulleys were attached to the servos, where they were spooled with strings (also referred to as tendons). To complete the design the tendons were unspooled through the case and fixed onto the case ahead of the current one. Additional add-on features like skins and wheels were also included and evaluated in the study.

The robot was powered using a DC power supply set to 11.7 Volts. The power supply was provided to the last servo motor at the robot tail. Power was supplied to the remaining servo motors through daisy chaining.

EXAMPLE I. A multi-legged robotic system was built to verify predictions. The robot was 3D-printed, and the printing material was PolyLite PLA. AX-12A and 2XL430-W250 motors control body undulation and limb retraction/protraction. The overall robot was composed of multiple repeating modules (FIG. 1A). Each module had three degrees of freedom (DoF): the shoulder lifting joint that controls the contact states of contralateral legs, the shoulder retraction joint that controls the fore/aft positions of leg movements, and the body bending joint that controls the lateral body undulation. Specifically, a leg up/down servo motor and a leg swing motor control the limb stepping and are connected by a hip connector (FIG. 1B). Those limb motors are connected with a body undulation motor with an undulation connector. The limb lifting connector which contains fishing lines (lines in FIG. 1A) connects the up/down motor and legs. Each leg is hinged to the hip connector using a rigid DoF revolute joint whose rotation axis is parallel to the fore-aft direction. The legs can lift up to 60° from their neutral position, which corresponds to maximum lift, about 7 cm above the ground (see inset of FIG. 1A). The leg lifting angles can be modulated by controlling the up/down motor. The leg swing angle, θ, and the lateral body angle, α, are actively controlled by a leg swing motor and a body undulation motor (FIG. 1B). The final design of a module (length=15 cm) with three servos is given in FIG. 1. This modular design allows us to readily change the number of the modules (and legs) of the robot. Experimental verification was performed of the prediction model by changing modules of the robophysical model (three to eight modules corresponding to six to sixteen-legged robotics system).

Inspired by real centipede animals, rubber bands (¼ LB) were used to design two types of leg compliance to minimize the parallel force disturbance. The first intelligent design is inward leg compliance (FIG. 2A). Rubber bands connect legs and hip joint connector and support the body weight of each robot module by drag forces. The contralateral legs from the same module are 180° out of phase with each other. Instead of independently actuating two legs, this inward compliance can couple two legs with only one motor. FIG. 2A shows an example of how this design works. The up/down motor rotates and fastens the fishing line to lift the right leg. Then the motor returns to its neutral position, whereas the return rubber band drags the right leg down to its neutral position.

The second compliance design is the longitudinal leg compliance. This design enables the leg to bend passively when hitting obstacles and subsequently slide on obstacles to pass (FIG. 2B). The return rubber band, together with a rotation pivot, connects the upper part and lower part of a leg. The lower part bends passively when hitting an obstacle, then the leg can slide on the obstacle and finally pass it. After passing, the rubber band returns/recovers the lower part to its neutral position.

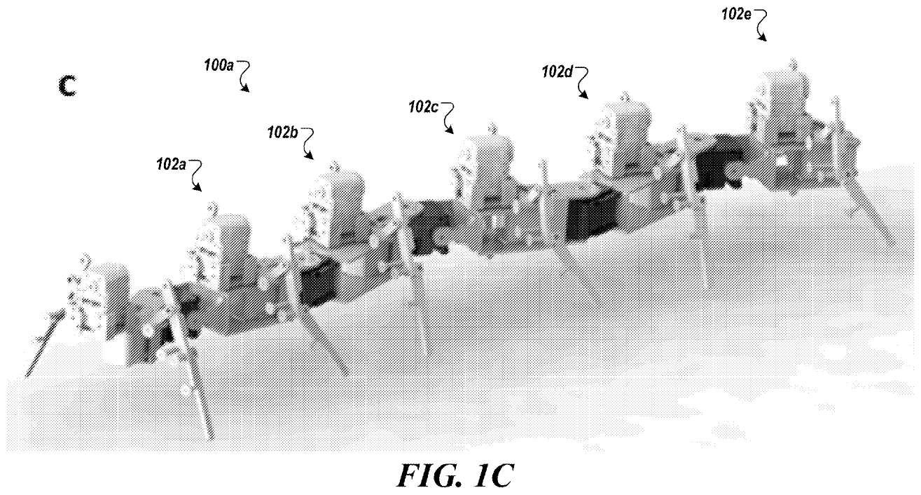

The Dynamixel SDK library was used to develop control code for the robophysical model and finish programming in MATLAB. The PC input control signals to the robot via Robotis U2D2 while a DC power supply HY3050E provides power for the motors (FIG. 3). The voltage of the power supply is set as 11.1 V, which is the recommended input voltage of AX 12A and 2XL430-W250 motors.

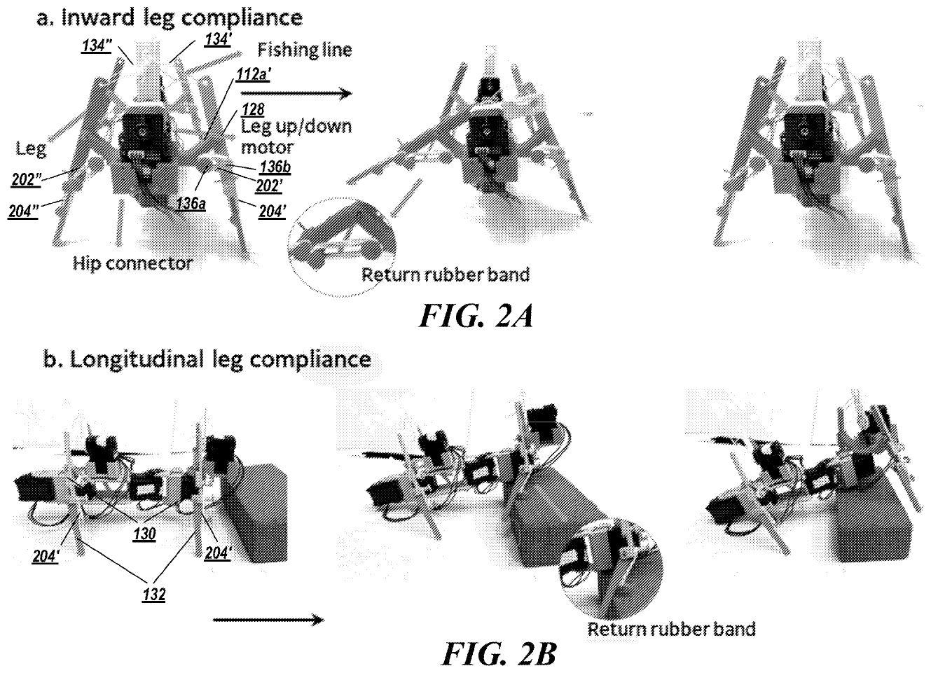

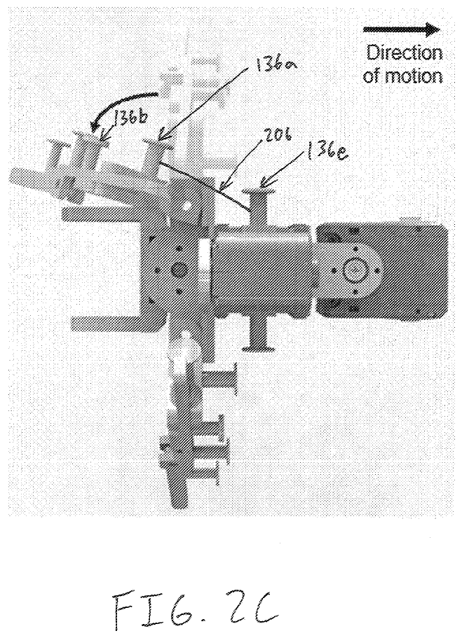

FIG. 4A shows a perspective view of the tracking system setup for evaluating movement of the robots in the study. FIG. 4B is a perspective view of the limbed robotic system of FIG. 1C with mounted markers.

Four Opti Track prime model 13w cameras were used to track the movement of the robot and collect/analyze experiment results. Four cameras were mounted on the four tripods and are placed at each corner of the robot testing arena (FIG. 4). The tracking system was calibrated by CW-500 Calibration Wand Kit and CS-400 Calibration Square. Markers are mounted on the top of each leg up/down motor for capturing. Motive was used as the motion capture software to collect tracking data.

A binary variable c was used to represent the contact state of a leg, where c=1 represents the stance phase and c=0 represents the swing phase. Following [1], the contact pattern of robophysical model with N pairs of legs can be written as:

$${θ}_{l} ( {τ}_{c} , 1 ) = \{ \begin{matrix}1 , & if mod ( {τ}_{c} , 2 π ) < 2 π D \\ 0 , & otherwise\end{matrix} \\ {θ}_{l} ( {τ}_{c} , 1 ) = {θ}_{l} ( {τ}_{c} - 2 π \frac{ξ}{N} ( i - 1 ) , 1 ) \\ {θ}_{l} ( {τ}_{c} , 1 ) = {θ}_{l} ( {τ}_{c} + π , i ) \qquad ( Eq . Set 1 )$$

where ξ denotes the number of spatial waves on legs, D the duty factor, cₗ(τₑ, i) (and cᵣ(τ_{c}, i)) denotes the contact state of i-th leg on the left (and the right) at gait phase τ_{c}, i∈{1, . . . . N} for 2n-legged systems.

Legs can generate self-propulsion by protracting during the stance phase to make contact with the environment and retracting during the swing phase to break contact. That is, the leg can move from the anterior to the posterior end during the stance phase and moves from the posterior to the anterior end during the swing phase. In some embodiments, a piece-wise sinusoidal function may be used to prescribe the anterior/posterior excursion angles (θ) for a given contact phase (τ_{c}) defined per Equation Set #1 where:

$${θ}_{l} ( {τ}_{c} , 1 ) = \{ \begin{matrix}{Θ}_{leg} cos ( \frac{{τ}_{c}}{2 D} ) , & if mod ( {τ}_{c} , 2 π ) < 2 π D \\ - {Θ}_{leg} cos ( \frac{{τ}_{c} - 2 π D}{2 ( 1 - D )} ) , & otherwise\end{matrix} \\ {θ}_{l} ( {τ}_{c} , 1 ) = {θ}_{l} ( {τ}_{c} - 2 π \frac{ξ}{N} ( i - 1 ) , 1 ) \\ {θ}_{l} ( {τ}_{c} , 1 ) = {θ}_{l} ( {τ}_{c} + π , i ) \qquad ( Eq . Set 2 )$$

in which Θ_{leg} is the shoulder angle amplitude, θₗ(τ_{c}, i) and θᵣ(τ_{c}, i) denote the leg shoulder angle of i-th left and right leg at contact phase τ_{c}, respectively. The shoulder angle may be maximum (θ=Θ_{leg}) at the transition from swing to stance phase and is minimum (θ=−Θ_{leg}) at the transition from stance to swing phase. For example, D=0.5 can be chosen.

Lateral body undulation can be introduced by propagating a wave along the backbone from head to tail. The body undulation wave is

$$α ( {τ}_{b} , i ) = {Θ}_{body} cos ( {τ}_{b} - 2 π \frac{{ξ}^{b}}{N} ( i - 1 ) ) \qquad ( Eq . 3 )$$

where α(τ_{b}, i) is the angle of i-th body joint at phase τ_{b}, ξ_{b} denotes the number of spatial waves on the body. For simplicity, it is assumed that the spatial frequency of the body undulation wave and the contact pattern wave is the same, i.e., ξ_{b}=ξ. Gaits of multi-legged locomotors by superposition of a body wave, and a leg wave can be described as the phase of contact, ϕ_{c}, and the phase of lateral body undulation τ_{b}. As discussed in [43], the optimal body-leg coordination (optimal phasing of body undulation to assist leg retraction) may be ϕ_{c}=τ_{b}−(ξ/N+1/2)π. In the study, Θ_{leg}=π/6, Θ_{body}=π/6, ξ=N/6 were used for all experiments.

EXAMPLE #2. A fundamental component of the limbless robots considered in the study is the module. To assemble the robots described herein, the individual modules were attached to one another, forming a “chain” of modules that are each individually controlled to allow for different body shapes. The study evaluated a system comprising eight linked modules.

The study used active tendons that run along both edges of the modules. Each tendon was independently controlled using a pulley mechanism attached to a servo motor. These tendons closely mimic the musculature of animals such as snakes. Compared to traditional “serially-linked” actuation that happens at the joint, the actuation methods used in the study not only more closely mimic the way the animals move but allow the development of new control strategies that have inherent passiveness, which has proven beneficial in not only traversing more difficult terrains but also improving limbless robot efficiency.

The overall design is made of multiple components that collectively form a chain of linked modules. Each individual module consists of two servo motors housed inside of a case. Cases are attached to one another using single joints. Then, small pulleys are attached to the servos, where they are spooled with strings, referred to here as tendons. To complete the design, the tendons are unspooled through the case and fixed onto the case ahead of the current one. Additional add-on features like skins and wheels are also included in the design.

Housed inside of each module included two independent servo motors. Servo motors as controllable actuators are often small, contained electronics for communication, and have a gear system to output different levels of torque. The design of the study utilized the Dynamixel 2XL430-W250-T servo motors. These specific servo motors were chosen for compact size, torque output, and range of motion.

The Dynamixel 2XL430-W250-T servos housed two controllable actuators within a single casing, meaning that by only installing one casing, there is still independent control of left and right tendons. Additionally, when navigating through uneven terrains, robot-environment interaction can require large amounts of torque. Dynamixel 2XL430-W250-T servos were rated to have a stall torque of 1.4 Nm. Lastly, many servo motors have a limited range of motion, e.g., allowing for only 180 or 360 degrees of rotation from the start point. While this has been enough for serially linked limbless robot designs because tendons rely on pulleys, the design of the study required multiple rotations. The continuous rotation of the Dynamixel 2XL430-W250-T allowed the pulleys to wind and unwound tendons without being limited by a strict range of motion.

The case that housed the servo motor was the main structural component that served as the skeleton of the module. To design each module as compact as possible, none of the already designed components, which are often used for attaching servo motors, were used. Instead, each case was custom designed and manufactured. Because of the unique geometries, the cases were 3D printed instead of laser cut or machined. The 3D printing material used was PLA due to its rigidity and availability. After the case is 3D printed, the study inserted heat insets into all of the holes using a soldering iron. These heat-insets were used to attach the case to other components such as the joint and wheels. Excluding the case for the head module, all of the other cases are identical and can be used interchangeably along the body. The head casing does not have the same rectangular shape as the body cases. Inspired by the rounded head shape of C. elegans and snakes, the case at the head is rounded. Such a head shape allows for smoother navigation around obstacles that the robot encounters head on.

The study connected each module with a single joint which allowed for only one axis of rotation, e.g., the parallel to the ground. In the study, the joints were custom-designed and 3D printed using PLA because of its rigidity. Each joint was designed to allow 180 degrees of rotation with a range of −90 to +90, with 0 degrees being the straight body position. Joints were attached using two small screws that connected directly to the heat insets. The design allowed for easy rearrangement and replacement of modules.

The study attached a single pulley to each of the two servo motors inside of each module. The pulleys were fixed to the servos using four small screws. The pulleys were custom designed to fit the case and 3D printed from PLA material. Varying pulley shapes were tested to optimize the design. While the smaller the pulley fit better onto the servo, small pulleys led to more unspooling of the string tendon, which was observed to lead to entanglement. The study prototyped different designs and running manual “spooling tests” to find a balance between the two competing design requirements.

To select the tendons, the study tested multiple different types of string and wires for the tendons. Rikimura braided fishing line was selected as the fishing line was specifically designed to support up to 180 pounds of force while having zero stretch and memory. Because the large torques that the robot can experience when interacting with the environment, the study found that such operation can cause weaker strings to either snap or plastically deform.

The study permanently attached one end of the tendon to the top of the pulley using super glue, and the rest was tightly wound around the pulley. Once the pulley had been attached to the servo motor, the tendon was carefully unspooled and passed through a small guiding hole on the edge of the case. This guiding hole ensured that the tendon left the case horizontally. Then, the tendon was brought outside of the case and attached to the case in front of the current one. This is done on the left and right sides for each module.

The tendons run alongside the length of the robot body resulting in an actuation method that closely resembles biological organisms. Similar to the exemplary robot, snakes and nematodes have muscles that run vertically down their bodies. By contracting and releasing these muscles, these organisms achieve excellent agility and maneuverability, which is the behavior the presented limbless robot seeks to mimic. To achieve this contracting and releasing behavior, the robot can actively turn on and off specific tendons along the body. When a tendon is tight and pulling on the module, it is considered “on.” Contrary, when the tendon is in a loose position and is neither pulling nor pushing the module, it is considered “off.” This ability allowed the fabricated robot to mimic patterns seen in biology.

The study used skin with a 1.5″ diameter elastic mesh sleeve that wrapped tightly around the entire length of the robot body. The study employed two purposes of the skin. The first was to create smooth body contact between the robot and the environment. Because the robot was made of modules that are open with exposed joints and pulleys, the robot could get snagged on debris depending on the terrain to be traversed. The uniformity the skin provides along the body can prevent undesired snagging. Also, the contact between the robot belly and the ground is similarly more uniform. The second function of the skin was to provide elasticity. The skin functions as a “passive” tendon ran along the length of the body. This meant that when the body was bent out of shape, there was always an inherent desire for the robot to return to the straight position. This elasticity allowed the robot to glide passively along obstacles that the body had interacted. Skin was also heavily preferred when traversing terrain where the robot interacted with obstacles that touched the side of the body.

The study evaluated wheels as attachable components that could readily attach or separate from the bottom of each module.

The wheels included a custom base and interlocking block wheels. The base was 3D printed from PLA to readily attach to the base of the module using four screws that inserted into the heat insets. The base had a small cutout in the bottom where an interlocking toy block was pressed in. A variety of small interlocking block wheels were attached and separated directly into the base of the robot.

Interlocking block wheels were employed at the base of the robot taking inspiration from scales of limbless organisms such as snakes. Scales on the underside of snakes can provide frictional anisotropy. That is, the scales on the belly of a snake could readily glide in the vertical direction, parallel to the length of the snake body while resisting gliding in the horizontal direction perpendicular to the snake body. This anisotropy appears to be key to limbless locomotion, especially on environments that are smooth. To test the fabricated limbless robot on smooth terrains, the study thus adjusted the frictional anisotropy at the base using interlocking block wheels. They allowed for easy gliding in the direction that the wheels want to roll, but the outer rubber tire could resist sliding in the direction perpendicular to the wheels. By adjusting the width and presence of the outer rubber tire, the study adjusted the frictional anisotropy of the robot to closely model the organisms that are being studied.

The study used a direct connection of a PC to a controller U2D2 to drive the Dynamixel servo motor. The U2D2 is a USB communication converter from Robotis that can allow for the direct control of Dynamixel motors from a PC. Since the servo motors were daisy chained with cables for both power and communication, the U2D2 board was connected to the last module. Using the build-in packages provided by Dyanmixel, namely the Protocol 2.0 packet, the study sent commands to the servo motors and acquired information tracking the torque and motor position.

With so many servo motors it could be difficult to properly wire the device. Specifically for the fabricated limbless robots, the wires were contained so that they would not be snagged and tangled with obstacles nor dragged along the ground, changing the body contact with the environment. In the study, all sixteen servo motors were daisy-chained together. Daisy chaining is a method of connecting different devices in series where module one connects to module two, which connects to module three, and so on. This resulted in the power source being only directly connected to the last servo motor is that it does not have to be individually routed to each servo. To address loose wiring present between consecutive modules, the system employed joints that are hollow. Wires were passed through a hole in the case and then directly fed inside of the joint until the wire extended into the following module. By hiding the wires inside of the joints, the robot was more reliable than in previous designs.

EXAMPLE #3. For a second version of the limbless robot, the study evaluated a robot with the ability to lift vertically. Using the same active-passive tendon strategy, extra second set of strings was added on the top and bottom of each module to have 3D control of the joint angle between modules. To accommodate for this flexibility, the study employed universal joints between modules to provide a combination of lateral and vertical bending capabilities.

The example design improved mobility by adding: (1) lifting modules that facilitate all-terrain locomotion (large steps, climbing), (2) new kinds of compliant appendages including tendons (strings) with higher strength and returning springs that enables serial elastic behaviors, (3) updated module and joint design that allow for larger joint angle limits and more available body postures, (4) proprioceptive and exteroceptive sensors (e.g., IMU, contact sensor, camera, etc.) for capabilities of sensing and interacting with the surrounding environment, (5) decentralized microcontrollers that control and monitor the motors and body proprioception feedback sensors in each module. Data generated by microcontrollers were recorded in situ for later transmittal or sent to a recording device in real-time using telemetry. The advanced robot design with natural mechanical directional compliance inherited from tendon actuation is capable of exploiting robot-environment interactions and locomoting smoothly in complex environments.

Inspired by the bilateral actuation scheme, a new type of limbless robot was designed to emulate the muscle-skeleton structure of limbless biological locomotors. Like conventional limbless robots, the limbless robot had a spine consisting of a series of rigid vertebrae made of hard materials. Instead of actuating the spine directly at joints that connect neighboring vertebrae, the robot actuated its spine by contracting and relaxing compliant “tendons” (string-pulley-motor systems) around joints. Each tendon can contract to bend the joint in one direction; thus, a pair of tendons can bend the joint in either direction. The tendon-driven limbless robot inherited the flexibility brought by the hyper-redundant body and furthermore introduces intrinsic mechanical compliance and built-in capability to passively respond to environmental perturbations. By contracting and relaxing tendons on either side, each joint in the tendon-driven limbless robot could be controlled in a compliant way, i.e., changing the compliant of a single joint by varying the lengths of both tendons, e.g., to be rigid when both are tightened, and to be completely compliant when both are loosened. With a single joint, compliance was tunable in which the “stiffness” of the body is tunable in a decentralized way and in which stiffness of the different portion of the body could be varied.

Some limbless organisms, like certain snake and worm species, can react to contacts by adjusting the posture of the specific portion of the body to generate propulsive forces while contacting multiple obstacles. Such a decentralized control strategy allowed limbless locomotors to maneuver agilely in complex heterogeneous environments. The study employed a bio-inspired decentralized reactive feedback control framework to allow the robot to locomote in obstacle-rich environments, specifically using decentralized control schemes in which tendons are naturally distributed in a decentralized manner and in which all tendons are actuated independently. For a decentralized control framework for the tendon-driven limbless robot, the study leveraged principles of neuromechanical control in a model of the limbless biological locomotor: C. elegans. The study took inspiration from a theoretical neuromechanical model of C. elegans and integrated mechanical forces, neuronal coupling, and sensory feedback mechanisms to characterize the undulatory forward gait.

The study built a similar decentralized reactive control network that integrated local proprioceptive sensing and neuronal coupling of the robot. The robot can thus react to perturbations and adapt its gait to the environment by altering parameters in local tendon actuation patterns. Modular local controllers were also integrated with inter-module communication so that neighboring modules are coupled, and the immediate motion can be propagated along the body. The study used the bending information at each module to determine the onset of activation in the subsequent module. Once the bending at the present module has crossed a threshold value, the control would deactivate the tendons in the present module, while control in the subsequent module would direct the tendons to become active. Mimicking the neuromechanical control in C. elegans, it was observed that the robot could respond to environmental perturbations locally without centralized commands.

### DISCUSSION

Limbless robots are underactuated robots that are traditionally comprised of a series of modules. By utilizing strategic body-shape changes, usually inspired by organisms such as snakes, worms, or nematodes, these robots can traverse diverse terrains. Because of their design, such robots have previously had success navigating flat terrain, pipes, and aquatic environments. The application of such robots is to aid in search and rescue missions, industrial inspection, and exploration of natural environments: forests, sand, and space. However, limbless robots still have had limited success in navigating obstacle obstacle-ridden terrain that which most closely matches the real-world environments they to which their biological have adapted are most useful for. Additionally To this end, these robots are still outperformed in efficiency by the organisms that they are modelled after. The presented limbless robot design is meant to addresses several of these current limitations with those of the state of the art by investigating the anatomy of limbless organisms and adjusting including our design features to more closely match the way these organisms move their bodies.

It should be appreciated that the logical operations described above and in the appendix can be implemented (1) as a sequence of computer-implemented acts or program modules running on a computing system and/or (2) as interconnected machine logic circuits or circuit modules within the computing system, as well as with electric circuits. The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The processing unit may be a programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.
[1] R. J. Full and M. S. Tu, “Mechanics of a rapid running insect: two-, four- and six-legged locomotion,” Journal of Experimental Biology, vol. 156, no. 1, pp. 215-231, 1991.
[2] C. F. Herreid, D. A. Prawel, and R. J. Full, “Energetics of running cockroaches,” Science, vol. 212, no. 4492, pp. 331-333, 1981.
[3] R. J. Full, D. R. Stokes, A. N. Ahn, and R. K. Josephson, “Energy absorption during running by leg muscles in a cockroach,” Journal of Experimental Biology, vol. 201, no. 7, pp. 997-1012, 1998.
[4] J. T. Watson, R. E. Ritzmann, S. N. Zill, and A. J. Pollack, “Control of obstacle climbing in the cockroach, blaberus discoidalis. i. kinematics,” Journal of Comparative Physiology A, vol. 188, no. 1, pp. 39-53, February 2002.
[5] W. A. Lewinger, C. M. Harley, M. S. Watson, M. S. Branicky, R. E. Ritzmann, and R. D. Quinn, “Animal-inspired sensing for autonomously climbing or avoiding obstacles,” Applied Bionics and Biomechanics, vol. 6, no. 1, pp. 43-61, 2009.
[6] D. I. Goldman, T. S. Chen, D. M. Dudek, and R. J. Full, “Dynamics of rapid vertical climbing in cockroaches reveals a template,” Journal of Experimental Biology, vol. 209, no. 15, pp. 2990-3000, 2006.
[7] J. T. Watson, R. E. Ritzmann, and A. J. Pollack, “Control of climbing behavior in the cockroach, blaberus discoidalis. ii. motor activities associated with joint movement,” Journal of Comparative Physiology A, vol. 188, no. 1, pp. 55-69, February 2002.
[8] J. S. Gray, Animal locomotion. New York: Norton: The world naturalist, 1968.
[9] P. J. Csonka and K. J. Waldron, A Brief History of Legged Robotics. Dordrecht: Springer Netherlands, 2011, pp. 59-73.
[10] M. Raibert, K. Blankespoor, G. Nelson, and R. Playter, “Bigdog, the rough-terrain quadruped robot,” IFAC Proceedings Volumes, vol. 41, no. 2, pp. 10 822-10 825, 2008, 17th IFAC World Congress.
[11] Y. Z. J. Z. Jie Chen, Zhongchao Liang, “Improving kinematic flexibility and walking performance of a six-legged ro-bot by rationally designing leg morphology,” Journal of Bionic Engineering, vol. 16, no. 4, p. 608, 2019.
[12] S. M. La Valle, Planning Algorithms. New York, NY, USA: Cambridge University Press, 2006.
[13] J. R. Rebula, P. D. Neuhaus, B. V. Bonnlander, M. J. Johnson, and J. E. Pratt, “A controller for the littledog quadruped walking on rough terrain,” in Proceedings 2007 IEEE International Conference on Robotics and Automation, April 2007, pp. 1467-1473.
[14] I. R. Manchester, U. Mettin, F. Iida, and R. Tedrake, “Stable dynamic walking over uneven terrain,” The International Journal of Robotics Research, vol. 30, no. 3, pp. 265-279, 2011.
[15] D. Pongas, M. Mistry, and S. Schaal, “A robust quadruped walking gait for traversing rough terrain,” in Proceedings 2007 IEEE International Conference on Robotics and Automation, April 2007, pp. 1474-1479.
[16] D. Rus and M. T. & Tolley, “Design fabrication and control of soft robots.” Nature, vol. 521, pp. 467-475, 2015.
[17] B. Trimmer, “Soft robots,” Current biology: CB, vol. 23, no. 15, p. R639-41, August 2013.
[18] H. Lipson, “Challenges and opportunities for design, simulation, and fabrication of soft robots,” Soft Robotics, vol. 1, no. 1, pp. 21-27, 2014.
[19] M. H. Dickinson, C. T. Farley, R. J. Full, M. A. R. Koehl, R. Kram, and S. Lehman, “How animals move: An integrative view,” Science, vol. 288, no. 5463, pp. 100-106, 2000.
[20] R. Altendorfer, N. Moore, H. Komsuoglu, M. Buehler, H. Brown, D. McMordie, U. Saranli, R. Full, and D. Koditschek, “Rhex: A biologically inspired hexapod runner,” Autonomous Robots, vol. 11, no. 3, pp. 207-213, November 2001.
[21] J. G. Cham, S. A. Bailey, J. E. Clark, R. J. Full, and M. R. Cutkosky, “Fast and robust: Hexapedal robots via shape deposition manufacturing,” The International Journal of Robotics Research, vol. 21, no. 10-11, pp. 869-882, 2002.
[22] S. Kim, M. Spenko, S. Trujillo, B. Heyneman, D. Santos, and M. R. Cutkosky, “Smooth vertical surface climbing with directional adhesion,” IEEE Transactions on Robotics, vol. 24, no. 1, pp. 65-74, February 2008.
[23] K. Jayaram and R. J. Full, “Cockroaches traverse crevices, crawl rapidly in confined spaces, and inspire a soft, legged robot,” Proceedings of the National Academy of Sciences, vol. 113, no. 8, pp. E950-E957, 2016.
[24] K. L. Hoffman and R. J. Wood, “Passive undulatory gaits enhance walking in a myriapod millirobot,” in 2011 IEEE/RSJ International Conference on Intelligent Robots and Systems, September 2011, pp. 1479-1486.
[25] Dooyeol Koh, Jaemin Yang, and Soohyun Kim, “Centipede robot for uneven terrain exploration: Design and experiment of the flexible biomimetic robot mechanism,” in 2010 3rd IEEE RAS EMBS International Conference on Biomedical Robotics and Biomechatronics, September 2010, pp. 877-881.
[26] T. Kinugasa, K. Osuka, R. Hayashi, N. Miyamoto, and K. Yoshida, “Development of a small and lightweight myriapod robot using passive dynamics,” Artificial Life and Robotics, vol. 22, no. 4, pp. 429-434, December 2017.
[27] A. S. Boxerbaum, J. Oro, G. Peterson, and R. D. Quinn, “The latest generation whegs robot features a passive-compliant body joint,” in 2008 IEEE/RSJ International Conference on Intelligent Robots and Systems, September 2008, pp. 1636-1641.
[28] A. M. Hoover and R. S. Fearing, “Fast scale prototyping for folded millirobots,” in 2008 IEEE International Conference on Robotics and Automation, May 2008, pp. 886-892.
[29] M. Hildebrand, “The quadrupedal gaits of vertebrates,” Bioscience, vol. 39, no. 11, p. 766, 12 1989.
[30] J. Aguilar, T. Zhang, F. Qian, M. Kingsbury, B. McInroe, N. Mazouchova, C. Li, R. Maladen, C. Gong, M. Travers et al., “A review on locomotion robophysics: the study of movement at the intersection of robotics, soft matter and dynamical systems,” Reports on Progress in Physics, vol. 79, no. 11, p. 110001, 2016.
[31] Y. Ozkan-Aydin, J. M. Rieser, C. M. Hubicki, W. Savoie, and D. I. Goldman, “Physics approaches to natural locomotion: Every robot is an experiment,” in Robotic Systems and Autonomous Platforms, ser. Woodhead Publishing in Materials, S. M. Walsh and M. S. Strano, Eds. Woodhead Publishing, 2019, pp. 109-127.
[32] S. M. Manton, “The evolution of arthropodan locomotory mechanisms,” Zoological Journal of the Linnean Society, vol. 51, no. 3-4, pp. 203-400, 1972.
[33] S. D. Kelly and R. M. Murray, “Geometric phases and robotic locomotion,” Journal of Field Robotics, vol. 12, no. 6, pp. 417-431, 1995.
[34] J. E. Marsden, “Geometric foundations of motion and control,” in Motion, Control, and Geometry: Proceedings of a Symposium, Board on Mathematical Science, National Research Council Education, National Academies Press, Washington, D C, 1997.
[35] J. E. Marsden and T. S. Ratiu, Introduction to mechanics and symmetry: a basic exposition of classical mechanical systems. Springer Science & Business Media, 2013, vol. 17.
[36] J. Ostrowski and J. Burdick, “The geometric mechanics of undulatory robotic locomotion,” The international journal of robotics research, vol. 17, no. 7, pp. 683-701, 1998.
[37] A. Shapere and F. Wilczek, “Geometry of self-propulsion at low reynolds number,” Journal of Fluid Mechanics, vol. 198, pp. 557-585, 1989.
[38] B. Anderson, J. Shultz, and B. Jayne, “Axial kinematics and muscle activity during terrestrial locomotion of the centipede scolopendra heros,” Journal of Experimental Biology, vol. 198, no. 5, pp. 1185-1195, 1995.
[39] M. Hildebrand, “Symmetrical gaits of horses,” Science, vol. 150, no. 3697, pp. 701-708, 1965.
[40] Y. O. Aydin, B. Chong, C. Gong, J. M. Rieser, J. W. Rankin, K. Michel, A. G. Nicieza, J. Hutchinson, H. Choset, and D. I. Goldman, “Geometric mechanics applied to tetrapod locomotion on granular media,” in Conference on Biomimetic and Biohybrid Systems. Springer, 2017, pp. 595-603.
[41] B. Zhong, Y. O. Aydin, C. Gong, G. Sartoretti, Y. Wu, J. Rieser, H. Xing, J. Rankin, K. Michel, A. Nicieza et al., “Coordination of back bending and leg movements for quadrupedal locomotion,” in Robotics: Science and Systems, 2018.
[42] C. Gong, Z. Ren, J. Whitman, J. Grover, B. Chong, and H. Choset, “Geometric motion planning for systems with toroidal and cylindrical shape spaces,” in ASME 2018 Dynamic Systems and Control Conference. American Society of Mechanical Engineers, 2018, pp. V003T32A013-V003T32A013.
[43] K. L. Hoffman and R. J. Wood, “Robustness of centipede-inspired millirobot locomotion to leg failures,” in 2013 IEEE/RSJ International Conference on Intelligent Robots and Systems, November 2013, pp. 1472-1479.
[44] B. Chong, Y. O. Aydin, J. M. Rieser, G. Sartoretti, T. Wang, J. Whitman, A. Kaba, E. Aydin, C. McFarland, K. D. Cruz, et al., A general locomotion control framework for multi-legged locomotors, Bioinspiration & Biomimetics 17, 046015 (2022).
[45] Yasemin Ozkan-Aydin, Baxi Chong, Enes Aydin, Daniel I. Goldman, “A systematic approach to creating terrain-capable hybrid soft/hard myriapod robots,” 2020 3^{rd} IEEE International Conference on Soft Robotics (RoboSoft). IEEE, 2020.

1. A limbed robotic module, the module comprising:
a frame;
a first leg motor rigidly coupled to the frame and having a first leg shaft that is rotatable about a first leg rotational axis;
a second leg motor rigidly coupled to the frame and having a second leg shaft that is rotatable about a second leg rotational axis, wherein the first leg rotational axis is transverse to the second leg rotational axis;
a yoke rigidly coupled to the first leg shaft such that rotation of the first leg shaft about the first leg rotational axis rotates the yoke relative to the frame, the yoke having a shoulder extending radially outwardly from the first leg rotational axis; and
a leg having a first leg end, a second leg end opposite and spaced apart from the first leg end, and a leg hinge portion disposed between the first leg end and the second leg end, the leg hinge portion being hingedly coupled to the shoulder of the yoke, wherein the first leg end is coupled to the second leg shaft such that rotation of the second leg shaft about the second leg rotational axis rotates the second leg end relative to the yoke.

2. The module of claim 1, wherein the shoulder of the yoke is a first shoulder, the yoke further comprising a second shoulder extending radially outwardly from the first leg rotational axis, wherein the leg is a first leg, the module further comprising:
a second leg having a first leg end, a second leg end opposite and spaced apart from the first leg end, and a leg hinge portion disposed between the first leg end of the second leg and the second leg end of the second leg, the leg hinge portion of the second leg being hingedly coupled to the second shoulder of the yoke, wherein the first leg end of the second leg is coupled to the second leg shaft such that rotation of the second leg shaft about the second leg rotational axis rotates the second leg end of the second leg relative to the yoke.

3. The module of claim 1, wherein the first leg end is coupled to the second leg shaft by a flexible leg tendon.

4. The module of claim 3, further comprising an extended linkage rigidly coupled to the second leg shaft, the extended linkage having a protrusion extending radially outwardly from the second leg rotational axis, wherein the flexible leg tendon is coupled to the protrusion.

5. The module of claim 1, wherein the leg comprises a first leg segment including the first leg end and a second leg segment including the second leg end, wherein the first leg segment is hingedly coupled to the second leg segment.

6. The module of claim 5, wherein the second leg segment is resiliently rotatable relative to the first leg segment such that the second leg segment is biased by a spring force toward a first leg position and urgable toward a second leg position, wherein an angle between a longitudinal axis of the first leg segment and a longitudinal axis of the second leg segment is larger in the first leg position than in the second leg position.

7. The module of claim 6, wherein the spring force is caused by a resilient member.

8. The module of claim 1, wherein the leg hinge portion is resiliently rotatable relative to the shoulder of the yoke such that the leg is biased by a spring force toward a first shoulder position and urgable toward a second shoulder position, wherein an angle between a longitudinal axis of the shoulder and a longitudinal axis of the leg is larger in the first shoulder position than in the second shoulder position.

9. The module of claim 8, wherein the spring force is caused by a resilient member.

10. The module of claim 1, wherein the first leg motor and the second leg motor are each servo motors.

11. A limbed robotic system, the system comprising:
a first module comprising:
a frame;
a first leg motor rigidly coupled to the frame and having a first leg shaft that is rotatable about a first leg rotational axis;
a second leg motor rigidly coupled to the frame and having a second leg shaft that is rotatable about a second leg rotational axis, wherein the first leg rotational axis is transverse to the second leg rotation axis;
a yoke rigidly coupled to the first leg shaft such that rotation of the first leg shaft about the first leg rotational axis rotates the yoke relative to the frame, the yoke having a shoulder extending radially outwardly from the first leg rotation axis; and
a leg having a first leg end, a second leg end opposite and spaced apart from the first leg end, and a leg hinge portion disposed between the first leg end and the second leg end, the leg hinge portion being hingedly coupled to the shoulder of the yoke, wherein the first leg end is coupled to the second leg shaft such that rotation of the second leg shaft about the second leg rotational axis rotates the second leg end relative to the yoke; and
a second module,
wherein the first module is hingedly coupled to the second module.

12. The system of claim 11, wherein the second module comprises:
a frame;
a first leg motor rigidly coupled to the frame and having a first leg shaft that is rotatable about a first leg rotational axis;
a second leg motor rigidly coupled to the frame and having a second leg shaft that is rotatable about a second leg rotational axis, wherein the first leg rotational axis is transverse to the second leg rotation axis;
a yoke rigidly coupled to the first leg shaft such that rotation of the first leg shaft about the first leg rotational axis rotates the yoke relative to the frame, the yoke having a shoulder extending radially outwardly from the first leg rotation axis; and
a leg having a first leg end, a second leg end opposite and spaced apart from the first leg end, and a leg hinge portion disposed between the first leg end and the second leg end, the leg hinge portion being hingedly coupled to the shoulder of the yoke, wherein the first leg end is coupled to the second leg shaft such that rotation of the second leg shaft about the second leg rotational axis rotates the second leg end relative to the yoke.

13. The system of claim 11, further comprising:
a third module comprising:
a frame;
a first leg motor rigidly coupled to the frame and having a first leg shaft that is rotatable about a first leg rotational axis;
a second leg motor rigidly coupled to the frame and having a second leg shaft that is rotatable about a second leg rotational axis, wherein the first leg rotational axis is transverse to the second leg rotation axis;
a yoke rigidly coupled to the first leg shaft such that rotation of the first leg shaft about the first leg rotational axis rotates the yoke relative to the frame, the yoke having a shoulder extending radially outwardly from the first leg rotation axis; and
a leg having a first leg end, a second leg end opposite and spaced apart from the first leg end, and a leg hinge portion disposed between the first leg end and the second leg end, the leg hinge portion being hingedly coupled to the shoulder of the yoke, wherein the first leg end is coupled to the second leg shaft such that rotation of the second leg shaft about the second leg rotational axis rotates the second leg end relative to the yoke,
wherein the second module is hingedly coupled to the third module.

14. The system of claim 11, wherein the first module further comprises:
a first body motor coupled to the frame of the first module and having a first body shaft that is rotatable about a first body rotational axis, wherein the second module is rigidly coupled to the first body shaft such that rotation of the first body shaft about the first body rotational axis rotates the second module relative to the first module; and
a second body motor coupled to the frame of the first module and having a second body shaft that is rotatable about a second body rotational axis, wherein the second body rotational axis is transverse to the first body rotational axis, wherein the frame of the first module is rigidly coupled to the second body shaft and the second body motor is rigidly coupled to the first body motor such that rotation of the second body shaft about the second body rotational axis rotates the second body motor relative to the frame of the first module.

15-17. (canceled)

18. The system of claim 11, the first module further comprising:
a first body motor rigidly coupled to the frame and having a first body shaft that is rotatable about a first body rotational axis;
a second body motor rigidly coupled to the frame and having a second body shaft that is rotatable about a second body rotational axis;
a first spool rigidly coupled to the first body shaft such that rotation of the first body shaft about the first body rotational axis rotates the first spool relative to the frame;
a second spool rigidly coupled to the second body shaft such that rotation of the second body shaft about the second body rotational axis rotates the second spool relative to the frame;
a flexible first body tendon having a first portion and a second portion spaced apart from the first portion, wherein the first portion of the first body tendon is coupled to the first spool such that rotation of the first spool about the first body rotational axis winds the first body tendon about the first spool; and
a flexible second body tendon having a first portion and a second portion spaced apart from the first portion, wherein the first portion of the second body tendon is coupled to the second spool such that rotation of the second spool about the second body rotational axis winds the second body tendon about the second spool,
wherein the second portion of the first body tendon and the second portion of the second body tendon are coupled to a frame of the second module such that winding of the first body tendon about the first spool causes the second module to rotate relative to the first module in a first direction and winding of the second body tendon about the second spool causes the second module to rotate relative to the first module in a second direction, wherein the first direction is an opposite rotational direction than the second direction.

19-21. (canceled)

22. The system of claim 18, wherein the second module is resiliently rotatable relative to the first module such that the second module is biased by a spring force via a resilient member toward a neutral position and urgable in the first direction, wherein a longitudinal axis of the first module is parallel to a longitudinal axis of the second module in the neutral position.

23-25. (canceled)

26. The system of claim 18, wherein the frame of the second module is hingedly coupled to the frame of the first module by a hinge joint, wherein the hinge joint defines an opening extending from the first module to the second module.

27. (canceled)

28. The system of claim 18, further comprising a first tendon guide and a second tendon guide, wherein the first body tendon extends through the first tendon guide and the second body tendon extends through the second tendon guide.

29. The system of claim 28, wherein a portion of the first body tendon extending from the first tendon guide to a frame of the second module is parallel to a longitudinal axis of the first module when the second module is in a neutral position, wherein a portion of the second body tendon extending from the second tendon guide to the frame of the second module is parallel to the longitudinal axis of the first module when the second module is in the neutral position, wherein the longitudinal axis of the first module is parallel to a longitudinal axis of the second module in the neutral position.

30-43. (canceled)

44. A limbless robotic system, the system comprising:
a first limbless robotic module, the first module comprising:
a frame;
a first body motor rigidly coupled to the frame and having a first body shaft that is rotatable about a first body rotational axis;
a second body motor rigidly coupled to the frame and having a second body shaft that is rotatable about a second body rotational axis;
a first spool rigidly coupled to the first body shaft such that rotation of the first body shaft about the first body rotational axis rotates the first spool relative to the frame;
a second spool rigidly coupled to the second body shaft such that rotation of the second body shaft about the second body rotational axis rotates the second spool relative to the frame;
a flexible first body tendon having a first portion and a second portion spaced apart from the first portion, wherein the first portion of the first body tendon is coupled to the first spool such that rotation of the first spool about the first body rotational axis winds the first body tendon about the first spool, and
a flexible second body tendon having a first portion and a second portion spaced apart from the first portion, wherein the first portion of the second body tendon is coupled to the second spool such that rotation of the second spool about the second body rotational axis winds the second body tendon about the second spool; and
a second module comprising a frame, wherein the frame of the second module is hingedly coupled to the frame of the first module,
wherein the second portion of the first body tendon of the first module and the second portion of the second body tendon of the first module are coupled to the frame of the second module such that winding of the first body tendon of the first module about the first spool of the first module causes the second module to rotate relative to the first module in a first direction and winding of the second body tendon of the first module about the second spool of the first module causes the second module to rotate relative to the first module in a second direction, wherein the first direction is an opposite rotational direction than the second direction.

45-59. (canceled)
